(19) United States
(12) Patent Application Publication
(10) Pub. No.: US 2025/0247858 A1
(43) Pub. Date: Jul. 31, 2025

(54) RESOURCE SELECTION, LISTEN-BEFORE TALK PROCEDURES, AND MAPPING OF PRIORITY AND QUALITY OF SERVICE INFORMATION FOR SIDELINK COMMUNICATION

(71) Applicant: Intel Corporation, Santa Clara, CA (US)

(72) Inventors: Salvatore Talarico, Santa Clara, CA (US); Kilian Roth, Munich (DE); Alexey Khoryaev, Santa Clara, CA (US); Sergey Panteleev, Kildare (IE); Mikhail Shilov, Santa Clara, CA (US)

(21) Appl. No.: 18/833,804

(22) PCT Filed: Apr. 17, 2023
(86) PCT No.: PCT/US2023/065859

§ 371 Date: Jul. 26, 2024

Related U.S. Application Data
(60) Provisional application No. 63/332,094, filed on Apr. 18, 2022.
(60) Provisional application No. 63/332,084, filed on Apr. 18, 2022.

(51) Int. Cl. H04W 72/25; H04W 74/08; H04W 74/0808

(52) U.S. Cl. CPC H04W 72/25; H04W 74/0808; H04W 74/0875

(57) ABSTRACT

Various embodiments herein provide techniques for sidelink communication on unlicensed spectrum. For example, embodiments include a sensing and resource selection (or reselection) procedure to select resources on which to perform a sidelink transmission. A listen-before-talk (LBT) procedure may be performed on the selected resources prior to the transmission. Embodiments further include techniques to handle LBT failures. Furthermore, embodiments provide techniques for mapping between a channel access priority class (CAPC) and a ProSe per packet priority (PPPP) and/or PC5 quality of service (QOS) indicator (PQI). Other embodiments may be described and claimed.

### CROSS REFERENCE TO RELATED APPLICATION

The present application claims priority to U.S. Provisional Patent Application No. 63/332,094, which was filed Apr. 18, 2022; and to U.S. Provisional Patent Application No. 63/332,084, which was filed Apr. 18, 2022.

### FIELD

Various embodiments generally may relate to the field of wireless communications. For example, some embodiments may relate to techniques for sidelink communication, such as in unlicensed spectrum.

### BACKGROUND

Mobile communication has evolved significantly from early voice systems to today's highly sophisticated integrated communication platform. The next generation wireless communication system, fifth generation (5G) (which may be additionally or alternatively referred to as new radio (NR)) may provide access to information and sharing of data anywhere, anytime by various users and applications. NR may be a unified network/system that target to meet vastly different and sometime conflicting performance dimensions and services. Such diverse multi-dimensional requirements may be driven by different services and applications.

For instance, in the third generation partnership project (3GPP) release-16 (Rel.16) specifications, sidelink (SL) communication was developed in radio access network (RAN) to support advanced vehicle-to-anything (V2X) applications. In release-17 (Rel.17), SA2 studied and standardized proximity based service including public safety and commercial related services and as part of Rel.17, power saving solutions (e.g., partial sensing, discontinuous reception (DRX), etc.) and inter-user equipment (UE) coordination have been developed to improve power consumption for battery limited terminals and reliability of SL transmissions. Although NR SL was initially developed for V2X applications, there is growing interest in the industry to expand the applicability of NR SL to commercial use cases, such as sensor information (e.g., video) sharing between vehicles with high degree of driving automation. For commercial SL applications, desirable features may include increased SL data rate and support of new carrier frequencies for SL. To achieve these elements, one objective in release-18 (Rel.18) is to extend SL operation in unlicensed spectrum (e.g., referred to as NR-U SL).

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates schematically illustrates New Radio-Unlicensed (NR-U) sidelink (SL) communication modes.

FIG. 2 schematically illustrates a Release 16 sensing and resource selection scheme.

FIG. 3 illustrates an example procedure that combines a LBT procedure with a SL sensing and resource selection procedure, in accordance with various embodiments.

FIG. 4 illustrates an example of a LBT procedure to determine and transmit on reserved but not utilized or not occupied resources in which a user equipment (UE) transmits right before a reserved resource, in accordance with various embodiments.

FIG. 5 illustrates an example of a LBT procedure to determine and transmit on reserved but not utilized or not occupied resources in which a UE performs a LBT procedure on a reserved resource, in accordance with various embodiments.

FIG. 6 illustrates an example of mapping of a channel access priority class (CAPC) and/or ProSe per packet priority (PPPP) to SL transmission priority for SL communication in unlicensed spectrum, in accordance with various embodiments.

FIG. 7 illustrates an example of a first UE (UE #1) indicating a request to acquire a channel occupancy time (COT) before a follow up transmission, which in this case falls within a second UE's (UE #2's) COT, wherein UE #2 initiates this COT after receiving indication from UE #1 that the UE #1's COT has been released, in accordance with various embodiments.

FIG. 8 schematically illustrates a wireless network in accordance with various embodiments.

FIG. 9 schematically illustrates components of a wireless network in accordance with various embodiments.

FIG. 10 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 11, 12, and 13 illustrate example processes for practicing the various embodiments herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

Various embodiments herein provide techniques for sidelink communication on unlicensed spectrum. For example, embodiments include a sensing and resource selection (or reselection) procedure to select resources on which to perform a sidelink transmission. A listen-before-talk (LBT) procedure may be performed on the selected resources prior to the transmission. Embodiments further include techniques to handle LBT failures. Furthermore, embodiments provide techniques for mapping between a channel access priority class (CAPC) and a ProSe per packet priority (PPPP) and/or PC5 quality of service (QOS) indicator (PQI).

As discussed above, one of the key objectives in Rel.18 is to extend SL operation in unlicensed spectrum (NR-U SL). However, note that to allow fair usage of the spectrum and fair coexistence among different technologies, different regional regulatory requirements are imposed worldwide. Thus, to enable a solution for all regions complying with the strictest regulation from ETSI BRAN published in EN 301 893 may be sufficient. For the development of NR-U during Rel.16 a 3GPP NR based system complying with these regulations was developed.

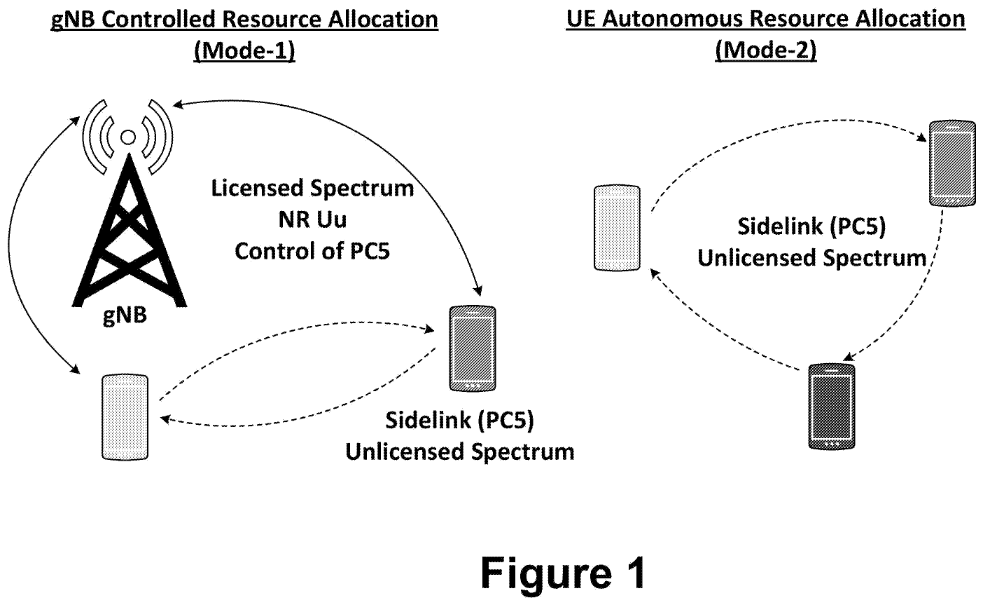

Within that said, given that the target is to enable a SL communication system in the unlicensed band, the considerations of SL communication systems need to be combined with the regulatory requirements necessary for the operation in the unlicensed bands. In particular, note that NR SL could be operated through two modes of operation: 1) mode-1, where a gNB schedules the SL transmission resource(s) to be used by the UE, and Uu operation is limited to licensed spectrum only; 2) mode-2, where a UE determines (e.g, gNB does not schedule) the SL transmission resource(s) within SL resources which are configured by the gNB/network or pre-configured. FIG. 1 illustrates the two modes of operation.

In this context, there are several specific challenges to enable NR-U SL. In particular, one of the challenges is that when operating in the FR-1 unlicensed band a listen before talk (LBT) procedure needs to be performed to acquire the medium before a transmission can occur.

### Sensing and Resource Selection

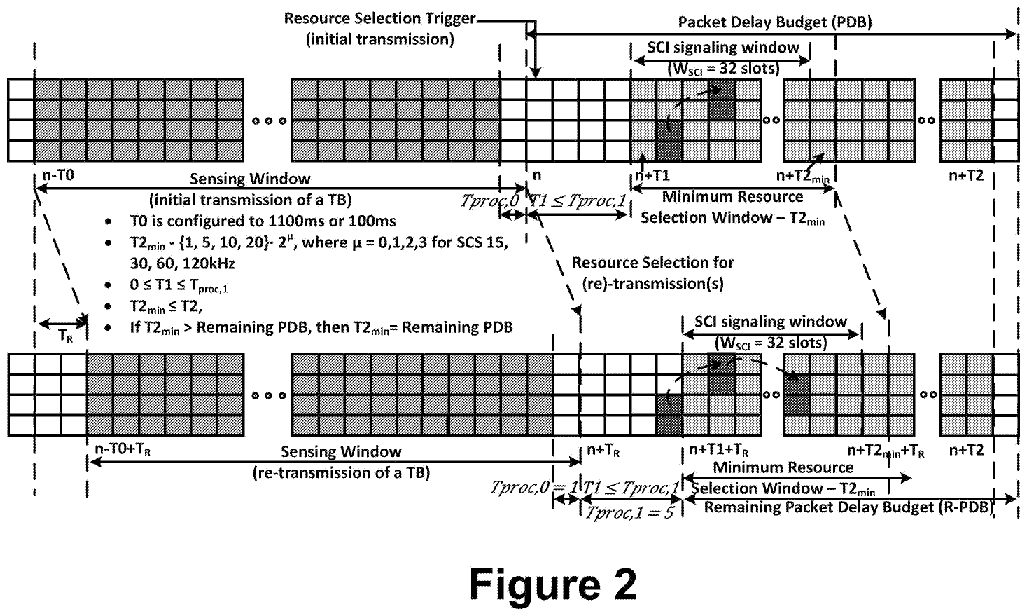

In Rel.16 SL, when operating in mode 2, some specific principles have been defined to allow a proper selection of the resources to be used by a UE, and in particular a sensing procedure has been established so that to scan the medium within a given window to establish beforehand a set of candidate resources that are suitable to be used or can be used within a given pool. The UE performs RSRP measurements, and compares such measurements with a specific threshold, which depends on the SL priority, to establish whether a specific resource if used will not create congestion or interfere with another SL UE. A summary schematic of the sensing and resource selection procedure is provided in FIG. 2.

Moving forward to Rel. 18, as mentioned above when a SL system is operated in unlicensed spectrum, the LBT is mandated to acquire a COT, or even within a COT, if COT sharing is allowed, based on the gap between SL transmission bursts within that COT. In accordance with various embodiments herein, given that LBT performs an instantaneous measurement of the medium and can be used as a method to determine whether a transmission or a resource could be used for a transmission, the sensing and resource selection scheme may be modified to include the LBT procedure in it. Various options for such a procedure are described herein in accordance with various embodiments. For example, multiple options are provided regarding how to relate the LBT procedure and the SL sensing and resource selection procedure. Furthermore, embodiments provide enhancements within the SL sensing and resource selection procedure.

Relationship of LBT with SL Sensing and Resource Selection Procedures

In one embodiment, for NR SL communication in unlicensed spectrum one or more of the following options may be used in accordance with various embodiments:

### Option 1-LBT Centric Design:

This option relies on LBT only operation and does not utilize components from the SL sensing and resource selection procedure. In this case, a UE may autonomously select from a configured pool of resources the one to utilize, and right before performing a transmission on that resource, perform the LBT procedure. In this case,
   In one sub-option, in order to assess whether a resource can be used or not, the energy measurement performed during the LBT is compared with an EDT which is set to the corresponding value of RSRP threshold indicated by the i-th field in sl-Thres-RSRP-List, where i=pᵢ+ (pⱼ−1)*8, and pᵢ is the SL priority i.
   In one sub-option, in order to assess whether a resource can be used or not, the energy measurement performed during the LBT is compared with an EDT as defined in 3GPP TS 37.213.
      Option 2-Combination of LBT Design w/SL Sensing and Resource Selection Design:
In this option, the LBT procedure can run independently, e.g., on top of the NR SL sensing and resource selection procedure. For instance, while the NR SL sensing and resource selection procedure can be reused, once the specific resource to use it selected a UE shall perform the LBT procedure before a transmission may occur.

### Option 3-Use of LBT Energy Detection Threshold for Sensing (Resource Exclusion) Operation:

In this option, the SL sensing and resource selection design is reused as a baseline and the SL-RSRP threshold for resource exclusion (that may be converted to energy detection (ED) threshold) is paired with the ED threshold defined in NR-U for unlicensed operation and described in TS 37.213. In this case, channel access thresholds can lead to the similar behavior in term of channel access.

### Option 4-Threshold Alignment+LBT

In this option, the SL sensing and resource selection design is reused as a baseline and SL-RSRP threshold for resource exclusion (that may be converted to the energy detection (ED) threshold) is paired with the ED threshold defined in NR-U for unlicensed operation and described in TS 37.213. Additionally, an LBT is performed before the actual transmission on the resource (e.g., performed within a given resource or at CP extension interval) that has been selected.

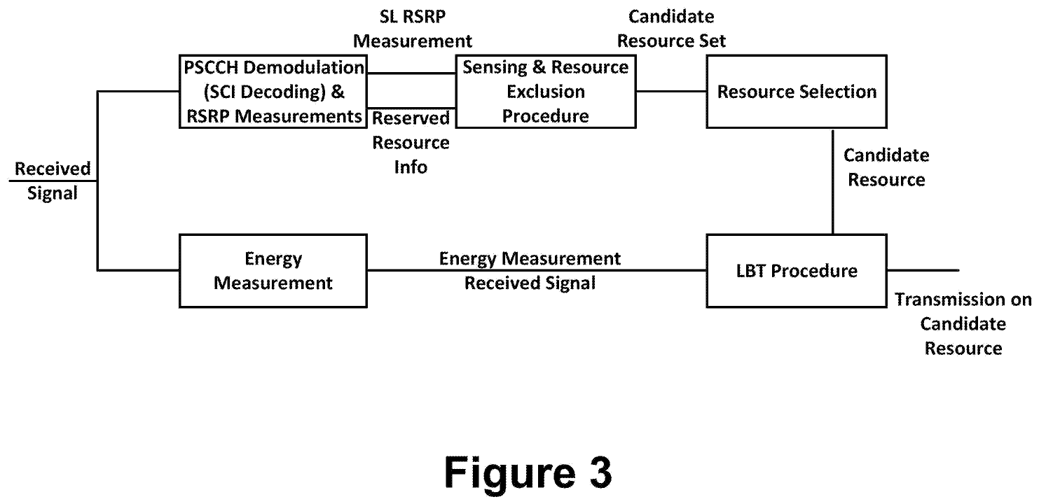

FIG. 3 illustrates an example procedure that combines the LBT procedure with the SL sensing and resource selection procedure, e.g., in accordance with Options 2, 3, and 4 described above.

In one embodiment, Option 1 may be mandated to be supported and additionally one or more other options (e.g., Option 2 or 3 or 4) are supported upon higher layer signaling configuration or UE's capability.

### LBT and Resource Selection Enhancements

In one embodiment, one or more of the following options may be used for enhancements of resource (re-) selection procedure for SL transmissions:

### Option 1-Back-to-Back Resource Selection+LBT:

In this option, resource selection of contiguous slots is supported.
   In one embodiment of this option, this can be enabled (e.g., by pre-configuration) for all SL transmissions or only if specific conditions are met (that can be controlled by pre-configuration), such one or more of the following:
      Packet delay budget (PDB) is less than pre-configured value;
      Remaining PDB is less than pre-configured value;
      Channel busy ratio (CBR) value is less than pre-configure value;
      Priority and/or CAPC conditions:
         TX UE is aware that among selected back-to-back resources, there are no reserved resources associated with higher or lower SL priority and/or CAPC.
   In one embodiment of this option, this can be considered in combination with existing NR SL sensing and resource selection procedure assuming that all UEs in the system additionally perform LBT procedure before SL transmission and thus other UEs cannot access the channel due to energy detection.
      Option 2—First in Time Resource Selection from Candidate Resource Set+LBT
Resources are selected from a candidate resource set in a back-to-back and first in time fashion. For instance, the earliest resource in time from a candidate resource set formed through the sensing and resource selection procedure are prioritized for selection, and LBT is performed before this resource could be used for a SL transmission.
   Option 3—Resource Selection from Candidate Resource Set+LBT
In this option, the sensing and resource selection procedure is complemented by an additional LBT procedure performed during the resource selection, which can be applied to decide whether a channel can be accessed for a SL transmission on an identified candidate resource. In this matter, once a candidate set of resources is formed, and the UE is associated with specific resource, that UE may either directly transmit or may be mandated to perform an additional LBT right before the SL transmission is performed on that resource.

### Transmission on Reserved Non-Utilized Resources

In one embodiment, an LBT procedure can be used to check if a previously reserved SL resource is not actually occupied/utilized (e.g., due to received ACK feedback or any other reason) and thus such resource can be considered as a candidate for UE SL transmission and channel access. This mechanism can be used for configured grant transmissions, and in one embodiment, one or more of the following options may be used:

### Option 1-Transmission Right Before Reserved Resource:

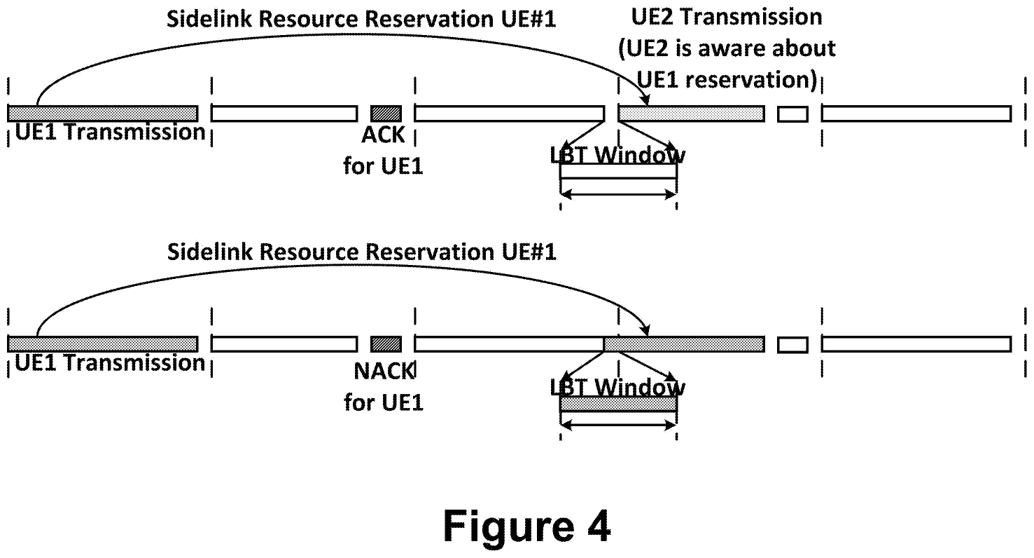

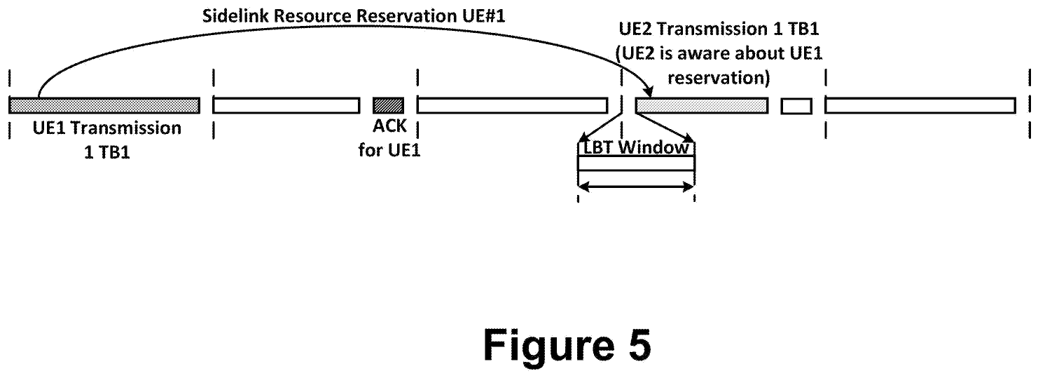

UE intending to transmit on reserved resource (e.g., received NACK) is expected to start transmission earlier (e.g., apply CP extension), so that its transmission can be detected by UEs performing LBT measurements right before reserved resources. FIG. 4 illustrates an example of this procedure.
   UE intending to transmit on reserved resource does not need to perform LBT, if it has detected PSCCH/PSSCH in the preceding slot indicating prolongation or requesting CP extension and can apply Type-2C LBT procedure only.
   UE intending to transmit on reserved resource need to perform LBT, if it has not detected PSCCH/PSSCH in the preceding slot indicating prolongation or requesting extension to apply Type-2C LBT procedure only. UE transmits on reserved resource if there is no LBT failure.
      Option 2-LBT Window within the Reserved Resource:
UE performs LBT within a reserved resource and access the channel if LBT is successful (e.g., no transmission is detected on reserved resource/energy is below pre-configured threshold, e.g., energy measured on reserved resource or wideband). FIG. 5 illustrates an example of this procedure.

### LBT Failure Detection and Reporting

When a system operates in unlicensed spectrum whether a specific transmission was not received due to poor channel conditions or due to an LBT failure at the transmitter is completely equivalent from a receiver point of view, and unless an explicit procedure/indication is established/provided it is not possible to discern the two events.

This may apply to a SL system, especially for unicast transmissions, where a feedback information is expected from another UE. In this case, unless the physical sidelink feedback channel (PSFCH) is qualified as a short control signaling and no LBT is applied to it when this is transmitted, the transmission of PSFCH will be conditional to the success of an LBT procedure and the UE can assess if the channel is clear. In this sense, from a UE perspective if the PSFCH related to a prior transmission is not received could be interpreted either as if the transmission was never received or the receiving UE was not able to transmit PSFCH due to a LBT failure, but it is unable to know exactly which one has occurred, and therefore a straightforward behavior will it to perform a retransmission. While to mitigate the issue that a PSFCH cannot be transmitted due an LBT failures, the retransmission could be triggered after a certain time defined by a timer to allow the receiving UE to attempt LBT multiple times. However, if a consistent LBT failure occurs at the receiving UE, this may not solve the problem, and the transmitting UE will be forced to continue to perform retransmissions while the receiving UE has indeed received the intended transmission.

Embodiments herein provide techniques to handle consistent LBT failures in SL, e.g., for both mode 1 and mode 2 SL operation. For example, when an LBT failure occurs at a UE for an intended SL transmission, that UE reports this event to the upper layers of the UE. The UE may count the LBT failures that occur within a specific time and send a report of consistent LBT failure if the number of LBT failures exceeds a threshold. The report may be sent, e.g., to a gNB or another UE. The receiving device may attempt to mitigate the issue, e.g., by proper resource management.

Another important aspect when enabling SL design in unlicensed spectrum is that when operating in dynamic channel access mode type 1 LBT is needed to be performed at the UE to initiate a channel occupancy time (COT). However, as detailed in Table I, the maximum COT that can be acquired with such LBT channel access type and some of the specifics of this type of LBT depends on a channel access priority class (CAPC), which is configured by the network based on type of traffic that a device may support and based on the quality of service (QOS) requirements that should be met.

TABLE I
Relationship between Channel Access
Priority Class (CAPC) and MCOT

| Channel | | | | | |
|---|---|---|---|---|---|
| Access | | | | | |
| Priority | | | | | allowed |
| Class (p) | mₚ | cw_{min, p} | cw_{max, p} | T_{ulm cot, p} | cwₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE1:
For p = 3,4,T_{ulm,cot, p} = 10 ms if the higher layer parameter absenseOfAnyOtherTechnology-r14 or absenceOfAnyOtherTechnology-r16 is provided, otherwise, T_{ulm,cot, p} = 6 ms.
NOTE2:
When T_{ulm,cot, p} = 6 ms it may be increased to 8 ms by inserting one or more gaps. The minimum duration of a gap shall be 100 us. The maximum duration before including any such gap shall be 6 ms.

As for the relationship between the CAPCs and the QoS control indicators (QCIs), this is summarized by Table II, while Table III provides the details in terms of priority level, packet delay budget and packet error rate for each QCI.

TABLE II
Mapping between CAPC and QCI

| Channel Access Priority Class | OCI |
|---|---|
| 1 | 1, 3, 5, 65, 66, 69, 70 |
| 2 | 2, 7 |
| 3 | 4, 6, 8, 9 |
| 4 | — |

TABLE III
QCI to QoS characteristics mapping

| | | | | | Packet | |
|---|---|---|---|---|---|---|
| | | | Packet | | Error | |
| | Resource | Priority | Delay | | Loss | |
| QCI | Type | Level | Budget | | Rate | Example Services |
| 1 | GBR | 2 | 100 | ms | 10⁻² | Conversational Voice |
| 2 | | 4 | 150 | ms | 10⁻³ | Conversational Video (Live |
| | | | | | | Streaming) |
| 3 | | 3 | 50 | ms | 10⁻³ | Real Time Gaming, V2X messages |
| | | | | | | Electricity distribution - medium |
| | | | | | | voltage (e.g. clause 7.2.2 of |
| | | | | | | TS 22.261 [51]) |
| | | | | | | Process automation - monitoring |
| | | | | | | (e.g. clause 7.2.2 of TS 22.261 [51]) |
| 4 | | 5 | 300 | ms | 10⁻⁶ | Non-Conversational Video |
| | | | | | | (Buffered Streaming) |
| 65 | | 0.7 | 75 | ms | 10⁻² | Mission Critical user plane Push To |
| | | | | | | Talk voice (e.g., MCPTT) |
| 66 | | 2 | 100 | ms | 10⁻² | Non-Mission-Critical user plane |
| | | | | | | Push To Talk voice |
| 5 | Non- | 1 | 100 | ms | 10⁻⁶ | IMS Signalling |
| 6 | GBR | 6 | 300 | ms | 10⁻⁶ | Video (Buffered Streaming) |
| | | | | | | TCP-based (e.g., www, e-mail, chat, |
| | | | | | | ftp, p2p file sharing, progressive |
| | | | | | | video, etc.) |
| 7 | | 7 | 100 | ms | 10⁻³ | Voice, Video (Live Streaming) |
| | | | | | | Interactive Gaming |
| 8 | | 8 | 300 | ms | 10⁻⁶ | Video (Buffered Streaming) |
| | | | | | | TCP-based (e.g., www, e-mail, chat, |
| | | | | | | ftp, p2p file sharing, progressive |
| | | | | | | video, etc.) |
| 9 | | 9 | 300 | ms | 10⁻⁶ | Video (Buffered Streaming) |
| | | | | | | TCP-based (e.g., www, e-mail, chat, |
| | | | | | | ftp, p2p file sharing, progressive |
| | | | | | | video, etc.) |
| 69 | | 0.5 | 60 | ms | 10⁻⁶ | Mission Critical delay sensitive |
| | | | | | | signalling (e.g., MC-PTT signalling, |
| | | | | | | MC Video signalling) |
| 70 | | 5.5 | 200 | ms | 10⁻⁶ | Mission Critical Data (e.g. example |
| | | | | | | services are the same as QCI 6/8/9) |

However, it is noted that for SL different QoS requirements have been defined which are mapped to specific PC5 5G NR Standardized QoS Identifiers (PQIs) as summarized in Table IV and indicated in physical layer through the related PQI via the SL ProSe Per Packet Priorities (PPPPs) indication provided within the SL control information (SCI).

TABLE IV
PQI to QoS characteristics mapping

| | | | | | | Default | | |
|---|---|---|---|---|---|---|---|---|
| | | | | | | Maximum | | |
| | | Default | Packet | | Packet | Data | Default | |
| PQI | Resource | Priority | Delay | | Error | Burst | Averaging | Example |
| Value | Type | Level | Budget | | Rate | Volume | Window | Services |
| 21 | GBR | 3 | 20 | ms | 10⁻⁴ | N/A | 2000 ms | Platooning |
| | (NOTE 1) | | | | | | | between |
| | | | | | | | | UEs - |
| | | | | | | | | Higher |
| | | | | | | | | degree of |
| | | | | | | | | automation; |
| | | | | | | | | Platooning |
| | | | | | | | | between |
| | | | | | | | | UE and |
| | | | | | | | | RSU - |
| | | | | | | | | Higher |
| | | | | | | | | degree of |
| | | | | | | | | automation |
| 22 | | 4 | 50 | ms | 10⁻² | N/A | 2000 ms | Sensor |
| | | | | | | | | sharing - |
| | | | | | | | | higher |
| | | | | | | | | degree of |
| | | | | | | | | automation |
| 23 | | 3 | 100 | ms | 10⁻⁴ | N/A | 2000 ms | Information |
| | | | | | | | | sharing for |
| | | | | | | | | automated |
| | | | | | | | | driving - |
| | | | | | | | | between |
| | | | | | | | | UEs or UE |
| | | | | | | | | and RSU - |
| | | | | | | | | higher |
| | | | | | | | | degree of |
| | | | | | | | | automation |
| 55 | Non- | 3 | 10 | ms | 10⁻⁴ | N/A | N/A | Cooperative |
| | GBR | | | | | | | lane change - |
| | | | | | | | | higher |
| | | | | | | | | degree of |
| | | | | | | | | automation |
| 56 | | 6 | 20 | ms | 10⁻¹ | N/A | N/A | Platooning |
| | | | | | | | | informative |
| | | | | | | | | exchange - |
| | | | | | | | | low degree |
| | | | | | | | | of |
| | | | | | | | | automation; |
| | | | | | | | | Platooning - |
| | | | | | | | | information |
| | | | | | | | | sharing |
| | | | | | | | | with RSU |
| 57 | | 5 | 25 | ms | 10⁻¹ | N/A | N/A | Cooperative |
| | | | | | | | | lane change - |
| | | | | | | | | lower |
| | | | | | | | | degree of |
| | | | | | | | | automation |
| 58 | | 4 | 100 | ms | 10⁻² | N/A | N/A | Sensor |
| | | | | | | | | information |
| | | | | | | | | sharing - |
| | | | | | | | | lower |
| | | | | | | | | degree of |
| | | | | | | | | automation |
| 59 | | 6 | 500 | ms | 10⁻¹ | N/A | N/A | Platooning - |
| | | | | | | | | reporting |
| | | | | | | | | to an RSU |
| 90 | Delay | 3 | 10 | ms | 10⁻⁴ | 2000 bytes | 2000 ms | Cooperative |
| | Critical | | | | | | | collision |
| | GBR | | | | | | | avoidance; |
| | (NOTE 1) | | | | | | | Sensor |
| | | | | | | | | sharing - |
| | | | | | | | | Higher |
| | | | | | | | | degree of |
| | | | | | | | | automation; |
| | | | | | | | | Video |
| | | | | | | | | sharing - |
| | | | | | | | | higher |
| | | | | | | | | degree of |
| | | | | | | | | automation |
| 91 | | 2 | 3 | ms | 10⁻⁵ | 2000 bytes | 2000 ms | Emergency |
| | | | | | | | | trajectory |
| | | | | | | | | alignment; |
| | | | | | | | | Sensor |
| | | | | | | | | sharing - |
| | | | | | | | | Higher |
| | | | | | | | | degree of |
| | | | | | | | | automation |

(NOTE 1):
GBR and Delay Critical GBR PQIs can only be used for unicast PC5 communications.

Various embodiments herein provide techniques for mapping between CAPCs and PPPPs. Given that the information related to CAPC is necessary for unlicensed operation, but the CAPC will be referencing and will be configured based on different QoS, some mapping between CAPCs and PPPPs may be needed.

Another aspect described herein is allowing a SL system operating in unlicensed spectrum to offer a further degree of coordination in terms of COT sharing, thereby allowing better spectrum utilization. Coordination can be used to allow UE to request to have another device to initiate the COT and share its COT so that the UE's transmission may fall within that device's COT and may operate as responding device. Multiple such schemes are described in this disclosure for both mode 1 and mode 2 SL operation.

### Reporting of SL COT Sharing Failure

As mentioned above, when a system operates in unlicensed spectrum whether a specific transmission was not received due to poor channel conditions or due to an LBT failure at the transmitter is completely equivalent from a receiver point of view, and unless an explicit procedure/indication is established/provided it is not possible to discern the two events. In SL, for instance, the transmission of PSFCH will be conditional to the success of an LBT procedure and the UE to assess that the channel is clear. Accordingly, from a UE perspective if the PSFCH related to a prior transmission is not received could be interpreted either as if the transmission was never received or the receiving UE was not able to transmit PSFCH due an LBT failure, but it is unable to know exactly which one has occurred, and therefore a straightforward behavior will be to perform a retransmission. While to mitigate the issue that a PSFCH cannot be transmitted due an LBT failures, the retransmission could be triggered after a certain time defined by a timer to allow the receiving UE to attempt LBT multiple times. However, if a consistent LBT failure occurs at the receiving UE, this may not solve the problem, and the transmitting UE will be forced to continue to perform retransmissions while the receiving UE has indeed received the intended transmission. Therefore, a method to signal either the network or other UEs in regards of a consistent LB T failure is advantageous so that different scheduling or behavior could be taken in this case.

In one embodiment, when a SL system operates in mode 1, one of the following options may be adopted:
Option 1: If a UE fails to access the channel(s) prior to an intended SL transmission, no action is needed by the UE.
Option 2: If a UE fails to access the channel(s) prior to an intended SL transmission, Layer 1 notifies higher layers about the channel access failure. In this matter, within the higher layers the device may count the LBT failures occurring within a specific time window. If the counting within a given time window is larger than a given threshold, this indicates that consistent LBT failure is occurring, and the device may report such indication back to the network when possible, so that the network could potentially make proper scheduling decisions to mitigate this issue.
   In one embodiment, this option could be applied if the SL transmission may carry one or more of the following SL physical channels:
      physical sidelink control channel (PSCCH)
      physical sidelink shared channel (PSSCH)
      physical sidelink feedback channel (PSFCH)
      physical sidelink broadcast channel (PSBCH)
      sidelink synchronization signal block (S-SSB)

In one embodiment, when a SL system operates in mode 2, one of the following options may be adopted:
Option 1: If a UE fails to access the channel(s) prior to an intended SL transmission, no action is needed by the UE.
Option 2: If a UE fails to access the channel(s) prior to an intended SL UL transmission, Layer 1 notifies higher layers about the channel access failure.
   In one embodiment, this option could be applied if the SL transmission may carry one or more of the following SL physical channels:
      PSCCH
      PSSCH
      PSFCH
      PSBCH
      S-SSB
   In one embodiment, the higher layers perform counting of the LBT failure per link (e.g., one counter per each UE which the TX UE is communication with), or per UE (e.g., a single counter is maintained per UE) or per group of UEs. If the counter within a given time window is larger than a given threshold, this indicates that consistent LBT failure is occurring, and the device may report such indication within a dedicate field in SCI (either stage 1 or stage 2 or both) in the following transmission to the specific UE for which the related counter has triggered consistent LBT failure, or to the group of UE for which the related counter has triggered consistent LBT failure or to any UEs, if the counter is maintained per UE.
Option 3: If a UE fails to access the channel(s) prior to an intended SL UL transmission, the UE may report such an event back to other UEs or the UE for which the transmission was intended by indicating this within a dedicate field in SCI (either stage 1 or stage 2 or both) in the following transmission to that or those UEs.
   In one embodiment, this option could be applied if the SL transmission may carry one or more of the following SL physical channels:
      PSCCH
      PSSCH
      PSFCH
      PSBCH
      S-SSB
         Relationship between SL Priorities and CAPCs

For NR SL communication, the PPPP was defined and mapped to SL transmission priority at radio layers, and as mentioned above this is correlated with specific QOS requirements that a transmission must meet. However, for NR-U operation the concept of CAPC was defined. Based on the CAPC configured/assigned by the network, a device upon succeeding type 1 LBT with proper LBT measurement details specific to the CAPC used, is allowed to transmit up to a different MCOT, as indicated in Table I. For NR-U, the choice of CAPC is determined by the network based on the QoS that should be met, and as indicated in Table II and Table III, there exists a relationship between CAPC and the QoS characteristics that a transmission should be ensuring.

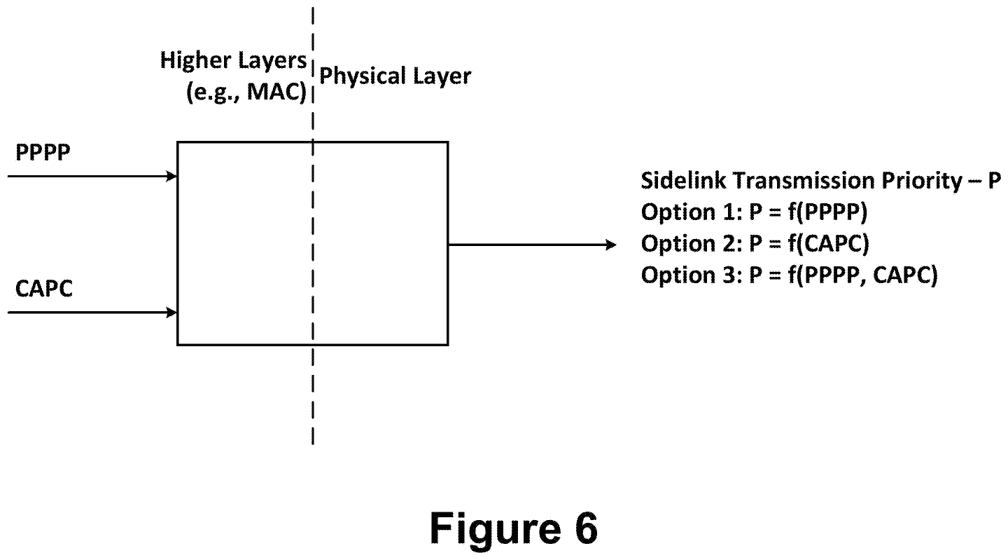

From physical layer perspective, it is desirable to indicate one parameter that can determine channel access behavior of the UE in terms of resource allocation, but also has a relationship with the QoS characteristic that must be met. In accordance with various embodiments herein, one of the following options could be adopted. FIG. 6 illustrates an example of the mapping of CAPC and/or PPPP to SL transmission priority for the options below.
Option 1: Only SL priorities based on PPPP are used for SL communication in unlicensed spectrum.
Option 2: Only CAPC is used for SL communication in unlicensed spectrum
In this case, CAPC is used for either 1) UE LBT-based channel access or 2) SL sensing and resource selection procedures, or for both.
In one sub-option, the bits used by the field carrying PPPP information in SCI are either ignored, or not used, and two additional bits are included in SCI to indicate the CAPC used. In a different sub-option, the bits used by the field carrying PPPP information in SCI are partially refurbished to carry 2 bits indication for CAPC, while the remaining bits are either removed from the SCI payload or ignored.
Option 3: SL priority (or CAPC) is redefined (or new parameter is introduced) based on PPPP and CAPC parameters.
In this case, CAPC is used for either 1) UE LBT-based channel access or 2) SL sensing and resource selection procedures, or for both.
   Option 3A: CAPC is used for SL communication in unlicensed spectrum, and the mapping between CAPC and QCI is enhanced to include the PQI for SL (e.g., 21, 22, 23, 55, 56, 57, 58, 59, 90, and 91).

As an example, the new mapping may be as illustrated in Table V.

TABLE V
Mapping between CAPC and QCI/PQI

| Channel Access Priority Class | QCI/PQI |
|---|---|
| 1 | 1, 3, 5, 65, 66, 69, 70, |
| | 21, 22, 55, 56, 57, 90, |
| 2 | 2, 7, 23, 58 |
| 3 | 4, 6, 8, 9, 59 |
| 4 | — |

In one option, the bits used by the field carrying PPPP information in SCI are either ignored, or not used, and two additionally bits are included in SCI to indicate the CAPC used.
In a different option, the bits used by the field carrying PPPP information in SCI are partially refurbished to carry 2 bits indication for CAPC, while the remaining bits are either removed from the SCI payload or ignored.
Option 3B: CAPC is used for SL communication in unlicensed spectrum, and a mapping between CAPC and PQI for SL (e.g., 21, 22, 23, 55, 56, 57, 58, 59, 90, and 91) is formed.

As an example, the new mapping may be as illustrated in Table VI.

TABLE VI
Mapping between CAPC and PQI

| Channel Access Priority Class | QCI/PQI |
|---|---|
| 1 | 21, 22, 55, 56, 57, 90, 91 |
| 2 | 23, 58 |
| 3 | 59 |
| 4 | — |

In one option, the bits used by the field carrying PPPP information in SCI are either ignored, or not used, and two additionally bits are included in SCI to indicate the CAPC used.
In a different option, the bits used by the field carrying PPPP information in SCI are partially refurbished to carry 2 bits indication for CAPC, while the remaining bits are either removed from the SCI payload or ignored.
Option 3C: PQIs are assigned to specific CAPCs or viceversa (for example using the mapping provided in Table V or Table VI), and the PPPP field in SCI jointly indicates the corresponding PQI and a CAPC.
Option 3D: a new parameter is defined, which jointly indicates PPPP and CAPC.
   In one option, the bits used by the field carrying PPPP information in SCI are either ignored, or not used, and additionally bits are included in SCI to indicate this new parameter.
   In a different option, the bits used by the field carrying PPPP information in SCI are refurbished to carry the bits indication this new parameter.
Option 4: Both CAPC and SL transmission priority are used, where SL transmission priority is a function of PPPP
In this option, CAPC can be used to determine LBT-based sidelink channel access procedures, while sidelink transmission priority can be reused for sidelink sensing and resource selection procedures.
In one option, the SCI payload (either stage 1 or stage 2 or both) can be extended to additionally contain an extra 2 bits to indicate CAPC. In a different option, some of the unused bits within SCI payload (either stage 1 or stage 2 or both) can be repurposed and used to carry 2 bits indication for CAPC.

### Method to Request to Initiate a SL COT

As discussed above, another possible enhancement that could be applied when a SL operates in mode-1, e.g., through a deployment where decoding/sensing from gNB may be allowed/possible, is to enable a further degree of coordination among devices by allowing a UE to request to have another device to initiate the COT and share its COT so that the UE's transmission may fall within that device's COT and may operate as responding device. This may be particularly useful for configured grant (CG) transmissions where the resources are pre-configured and dynamic allocation is not possible, and the allocated resource cannot be changed based on current buffer occupancy of the UE. Furthermore, this may be even more useful for CG transmissions with the cg-RetransmissionTimer is enabled, since a UE may operate in an autonomous manner and may in principle compete for resources with either gNB or other UEs, while the gNB may not know the current buffer occupancy of the UE.

In one embodiment, the SCI (either stage 1 or stage 2 or both) could be enhanced to contain one or more of the following information that could be used to achieve the aforementioned purpose:
Indication of the intention of the UE to request a COT, which can be interpreted as follows:
   Alt. 1: intention of the UE to request a COT from other device from following periodicity or periodicities.
   Alt. 2: intention of the UE to request a COT from other device from a specific starting time, which is indicated separately.
Start of requested time domain resources (either at slot or symbol granularity) where a UE is requesting some other device to acquire the COT
Amount of time for which a COT from another device is requested, which can indicate one of the following:
   Alt. 1: number of consecutive periodicities.
   Alt. 2: number of symbols or slots beginning from the start of the requested time domain resources, which can be separately indicated.

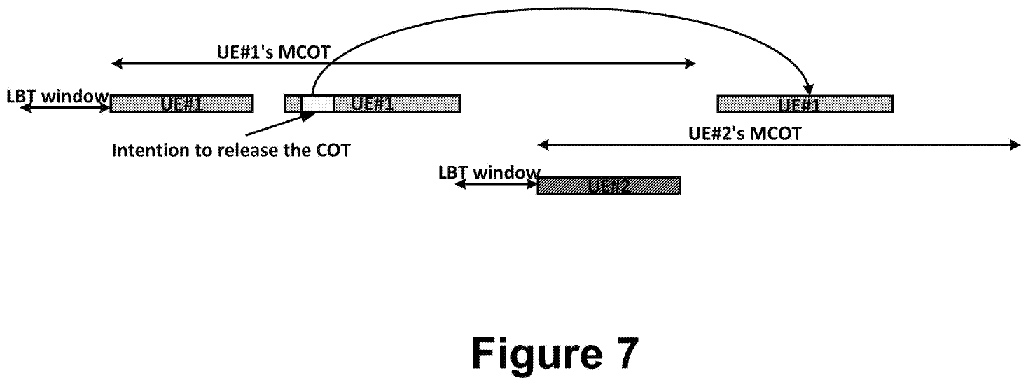

When a SL system operates in mode 2, a UE requesting another UE to initiate sidelink COT sharing may be particularly beneficial in case of unicast or groupcast communication, and one of the possible use cases may be when a UE that is the actual initiating device would like to release its COT, and allow another device to operate as an initiating device even if the MCOT for that device has not yet terminated in order to make sure that device may able to transmit later in time when its own MCOT may have terminated. This is illustrated in FIG. 7.

In one embodiment, when a SL system operates in mode 2, one of the following options could be adopted:
Option 1: an additional field could be carried in the SCI (either stage-1 or stage-2 or both) which indicates that the UE #1 would either like to release its COT if the transmission still belongs within its initial COT, or that despite of who is currently the initiating device, UE #1 would like to operate as responding device.
Option 2: the field indicating whether a device operate as initiating or responding device and/or the remaining COT information is used to release the COT:
   An initiating device may at a later time within its COT indicate that the remaining COT is 0, which may be interpreted by other devices as if that UE's COT has terminated.
      An initiating device may at a later time within its COT indicate that that it operates as a responding device, and jointly indicate the remaining COT is 0: this could be interpreted again by other devices as if that UE's COT has terminated, and that UE is requesting.

### Systems and Implementations

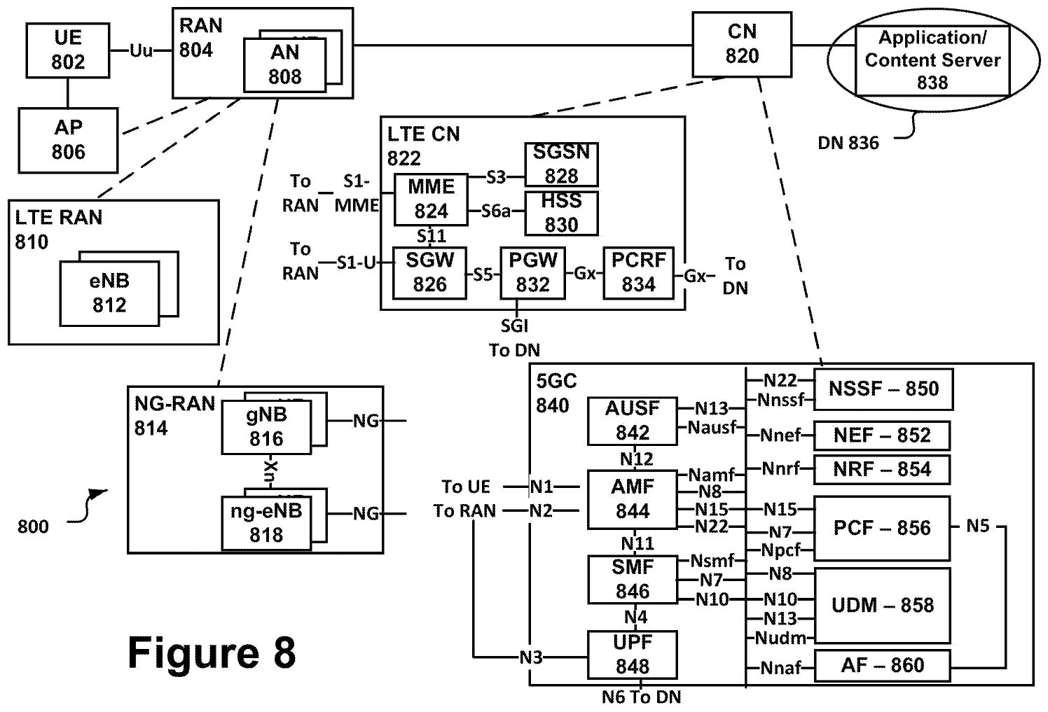

FIGS. 8-10 illustrate various systems, devices, and components that may implement aspects of disclosed embodiments.

FIG. 8 illustrates a network 800 in accordance with various embodiments. The network 800 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 800 may include a UE 802, which may include any mobile or non-mobile computing device designed to communicate with a RAN 804 via an over-the-air connection. The UE 802 may be communicatively coupled with the RAN 804 by a Uu interface. The UE 802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 800 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 802 may additionally communicate with an AP 806 via an over-the-air connection. The AP 806 may manage a WLAN connection, which may serve to offload some/all network traffic from the RAN 804. The connection between the UE 802 and the AP 806 may be consistent with any IEEE 802.11 protocol, wherein the AP 806 could be a wireless fidelity (Wi-Fi®) router. In some embodiments, the UE 802, RAN 804, and AP 806 may utilize cellular-WLAN aggregation (for example, LWA/LWIP). Cellular-WLAN aggregation may involve the UE 802 being configured by the RAN 804 to utilize both cellular radio resources and WLAN resources.

The RAN 804 may include one or more access nodes, for example, AN 808. AN 808 may terminate air-interface protocols for the UE 802 by providing access stratum protocols including RRC, PDCP, RLC, MAC, and LI protocols. In this manner, the AN 808 may enable data/voice connectivity between CN 820 and the UE 802. In some embodiments, the AN 808 may be implemented in a discrete device or as one or more software entities running on server computers as part of, for example, a virtual network, which may be referred to as a CRAN or virtual baseband unit pool. The AN 808 be referred to as a BS, gNB, RAN node, eNB, ng-eNB, NodeB, RSU, TRxP, TRP, etc. The AN 808 may be a macrocell base station or a low power base station for providing femtocells, picocells or other like cells having smaller coverage areas, smaller user capacity, or higher bandwidth compared to macrocells.

In embodiments in which the RAN 804 includes a plurality of ANs, they may be coupled with one another via an X2 interface (if the RAN 804 is an LTE RAN) or an Xn interface (if the RAN 804 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 804 may each manage one or more cells, cell groups, component carriers, etc. to provide the UE 802 with an air interface for network access. The UE 802 may be simultaneously connected with a plurality of cells provided by the same or different ANs of the RAN 804. For example, the UE 802 and RAN 804 may use carrier aggregation to allow the UE 802 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 804 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 802 or AN 808 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 804 may be an LTE RAN 810 with eNBs, for example, eNB 812. The LTE RAN 810 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 804 may be an NG-RAN 814 with gNBs, for example, gNB 816, or ng-eNBs, for example, ng-eNB 818. The gNB 816 may connect with 5G-enabled UEs using a 5G NR interface. The gNB 816 may connect with a 5G core through an NG interface, which may include an N2 interface or an N3 interface. The ng-eNB 818 may also connect with the 5G core through an NG interface, but may connect with a UE via an LTE air interface. The gNB 816 and the ng-eNB 818 may connect with each other over an Xn interface.

In some embodiments, the NG interface may be split into two parts, an NG user plane (NG-U) interface, which carries traffic data between the nodes of the NG-RAN 814 and a UPF 848 (e.g., N3 interface), and an NG control plane (NG-C) interface, which is a signaling interface between the nodes of the NG-RAN 814 and an AMF 844 (e.g., N2 interface).

The NG-RAN 814 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 802 can be configured with multiple BWPs where each BWP configuration has a different SCS. When a BWP change is indicated to the UE 802, the SCS of the transmission is changed as well. Another use case example of BWP is related to power saving. In particular, multiple BWPs can be configured for the UE 802 with different amount of frequency resources (for example, PRBs) to support data transmission under different traffic loading scenarios. A BWP containing a smaller number of PRBs can be used for data transmission with small traffic load while allowing power saving at the UE 802 and in some cases at the gNB 816. A BWP containing a larger number of PRBs can be used for scenarios with higher traffic load.

The RAN 804 is communicatively coupled to CN 820 that includes network elements to provide various functions to support data and telecommunications services to customers/subscribers (for example, users of UE 802). The components of the CN 820 may be implemented in one physical node or separate physical nodes. In some embodiments, NFV may be utilized to virtualize any or all of the functions provided by the network elements of the CN 820 onto physical compute/storage resources in servers, switches, etc. A logical instantiation of the CN 820 may be referred to as a network slice, and a logical instantiation of a portion of the CN 820 may be referred to as a network sub-slice.

In some embodiments, the CN 820 may be an LTE CN 822, which may also be referred to as an EPC. The LTE CN 822 may include MME 824, SGW 826, SGSN 828, HSS 830, PGW 832, and PCRF 834 coupled with one another over interfaces (or “reference points”) as shown. Functions of the elements of the LTE CN 822 may be briefly introduced as follows.

The MME 824 may implement mobility management functions to track a current location of the UE 802 to facilitate paging, bearer activation/deactivation, handovers, gateway selection, authentication, etc.

The SGW 826 may terminate an SI interface toward the RAN and route data packets between the RAN and the LTE CN 822. The SGW 826 may be a local mobility anchor point for inter-RAN node handovers and also may provide an anchor for inter-3GPP mobility. Other responsibilities may include lawful intercept, charging, and some policy enforcement.

The SGSN 828 may track a location of the UE 802 and perform security functions and access control. In addition, the SGSN 828 may perform inter-EPC node signaling for mobility between different RAT networks; PDN and S-GW selection as specified by MME 824; MME selection for handovers; etc. The S3 reference point between the MME 824 and the SGSN 828 may enable user and bearer information exchange for inter-3GPP access network mobility in idle/active states.

The HSS 830 may include a database for network users, including subscription-related information to support the network entities' handling of communication sessions. The HSS 830 can provide support for routing/roaming, authentication, authorization, naming/addressing resolution, location dependencies, etc. An S6a reference point between the HSS 830 and the MME 824 may enable transfer of subscription and authentication data for authenticating/authorizing user access to the LTE CN 820.

The PGW 832 may terminate an SGi interface toward a data network (DN) 836 that may include an application/content server 838. The PGW 832 may route data packets between the LTE CN 822 and the data network 836. The PGW 832 may be coupled with the SGW 826 by an S5 reference point to facilitate user plane tunneling and tunnel management. The PGW 832 may further include a node for policy enforcement and charging data collection (for example, PCEF). Additionally, the SGi reference point between the PGW 832 and the data network 836 may be an operator external public, a private PDN, or an intra-operator packet data network, for example, for provision of IMS services. The PGW 832 may be coupled with a PCRF 834 via a Gx reference point.

The PCRF 834 is the policy and charging control element of the LTE CN 822. The PCRF 834 may be communicatively coupled to the app/content server 838 to determine appropriate QoS and charging parameters for service flows. The PCRF 832 may provision associated rules into a PCEF (via Gx reference point) with appropriate TFT and QCI.

In some embodiments, the CN 820 may be a 5GC 840. The 5GC 840 may include an AUSF 842, AMF 844, SMF 846, UPF 848, NSSF 850, NEF 852, NRF 854, PCF 856, UDM 858, and AF 860 coupled with one another over interfaces (or “reference points”) as shown. Functions of the elements of the 5GC 840 may be briefly introduced as follows.

The AUSF 842 may store data for authentication of UE 802 and handle authentication-related functionality. The AUSF 842 may facilitate a common authentication framework for various access types. In addition to communicating with other elements of the 5GC 840 over reference points as shown, the AUSF 842 may exhibit an Nausf service-based interface.

The AMF 844 may allow other functions of the 5GC 840 to communicate with the UE 802 and the RAN 804 and to subscribe to notifications about mobility events with respect to the UE 802. The AMF 844 may be responsible for registration management (for example, for registering UE 802), connection management, reachability management, mobility management, lawful interception of AMF-related events, and access authentication and authorization. The AMF 844 may provide transport for SM messages between the UE 802 and the SMF 846, and act as a transparent proxy for routing SM messages. AMF 844 may also provide transport for SMS messages between UE 802 and an SMSF. AMF 844 may interact with the AUSF 842 and the UE 802 to perform various security anchor and context management functions. Furthermore, AMF 844 may be a termination point of a RAN CP interface, which may include or be an N2 reference point between the RAN 804 and the AMF 844; and the AMF 844 may be a termination point of NAS (N1) signaling, and perform NAS ciphering and integrity protection. AMF 844 may also support NAS signaling with the UE 802 over an N3 IWF interface.

The SMF 846 may be responsible for SM (for example, session establishment, tunnel management between UPF 848 and AN 808); UE IP address allocation and management (including optional authorization); selection and control of UP function; configuring traffic steering at UPF 848 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 844 over N2 to AN 808; and determining SSC mode of a session. SM may refer to management of a PDU session, and a PDU session or “session” may refer to a PDU connectivity service that provides or enables the exchange of PDUs between the UE 802 and the data network 836.

The UPF 848 may act as an anchor point for intra-RAT and inter-RAT mobility, an external PDU session point of interconnect to data network 836, and a branching point to support multi-homed PDU session. The UPF 848 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 848 may include an uplink classifier to support routing traffic flows to a data network.

The NSSF 850 may select a set of network slice instances serving the UE 802. The NSSF 850 may also determine allowed NSSAI and the mapping to the subscribed S-NSSAIs, if needed. The NSSF 850 may also determine the AMF set to be used to serve the UE 802, or a list of candidate AMFs based on a suitable configuration and possibly by querying the NRF 854. The selection of a set of network slice instances for the UE 802 may be triggered by the AMF 844 with which the UE 802 is registered by interacting with the NSSF 850, which may lead to a change of AMF. The NSSF 850 may interact with the AMF 844 via an N22 reference point; and may communicate with another NSSF in a visited network via an N31 reference point (not shown). Additionally, the NSSF 850 may exhibit an Nnssf service-based interface.

The NEF 852 may securely expose services and capabilities provided by 3GPP network functions for third party, internal exposure/re-exposure, AFs (e.g., AF 860), edge computing or fog computing systems, etc. In such embodiments, the NEF 852 may authenticate, authorize, or throttle the AFs. NEF 852 may also translate information exchanged with the AF 860 and information exchanged with internal network functions. For example, the NEF 852 may translate between an AF-Service-Identifier and an internal 5GC information. NEF 852 may also receive information from other NFs based on exposed capabilities of other NFs. This information may be stored at the NEF 852 as structured data, or at a data storage NF using standardized interfaces. The stored information can then be re-exposed by the NEF 852 to other NFs and AFs, or used for other purposes such as analytics. Additionally, the NEF 852 may exhibit an Nnef service-based interface.

The NRF 854 may support service discovery functions, receive NF discovery requests from NF instances, and provide the information of the discovered NF instances to the NF instances. NRF 854 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 854 may exhibit the Nnrf service-based interface.

The PCF 856 may provide policy rules to control plane functions to enforce them, and may also support unified policy framework to govern network behavior. The PCF 856 may also implement a front end to access subscription information relevant for policy decisions in a UDR of the UDM 858. In addition to communicating with functions over reference points as shown, the PCF 856 exhibit an Npcf service-based interface.

The UDM 858 may handle subscription-related information to support the network entities' handling of communication sessions, and may store subscription data of UE 802. For example, subscription data may be communicated via an N8 reference point between the UDM 858 and the AMF 844. The UDM 858 may include two parts, an application front end and a UDR. The UDR may store subscription data and policy data for the UDM 858 and the PCF 856, and/or structured data for exposure and application data (including PFDs for application detection, application request information for multiple UEs 802) for the NEF 852. The Nudr service-based interface may be exhibited by the UDR 221 to allow the UDM 858, PCF 856, and NEF 852 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 858 may exhibit the Nudm service-based interface.

The AF 860 may provide application influence on traffic routing, provide access to NEF, and interact with the policy framework for policy control.

In some embodiments, the 5GC 840 may enable edge computing by selecting operator/3rd party services to be geographically close to a point that the UE 802 is attached to the network. This may reduce latency and load on the network. To provide edge-computing implementations, the 5GC 840 may select a UPF 848 close to the UE 802 and execute traffic steering from the UPF 848 to data network 836 via the N6 interface. This may be based on the UE subscription data, UE location, and information provided by the AF 860. In this way, the AF 860 may influence UPF (re) selection and traffic routing. Based on operator deployment, when AF 860 is considered to be a trusted entity, the network operator may permit AF 860 to interact directly with relevant NFs. Additionally, the AF 860 may exhibit an Naf service-based interface.

The data network 836 may represent various network operator services, Internet access, or third party services that may be provided by one or more servers including, for example, application/content server 838.

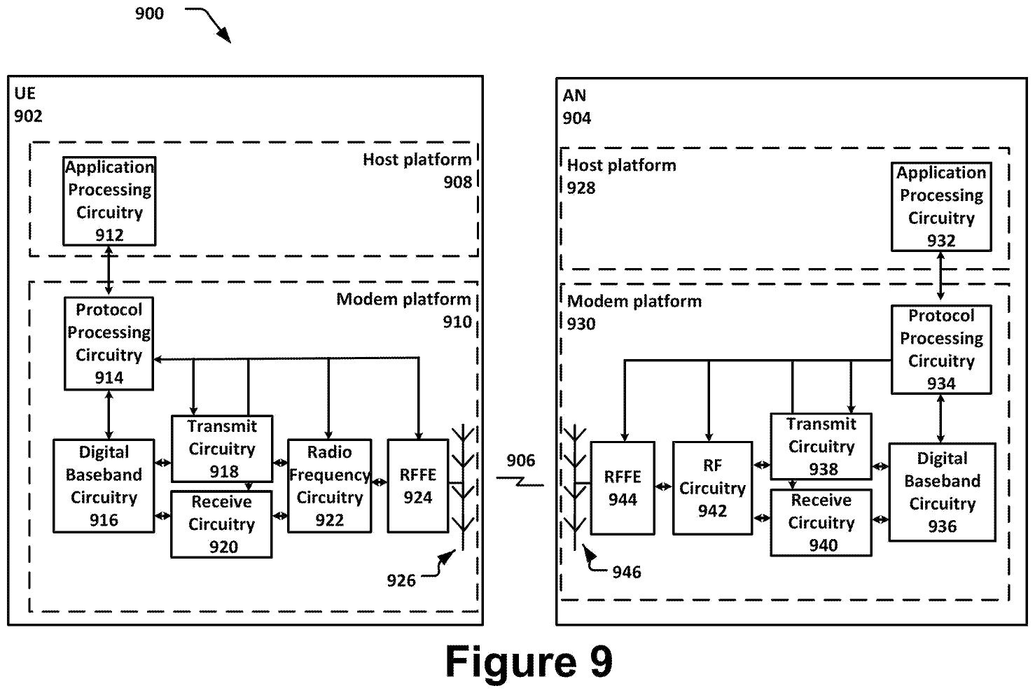

FIG. 9 schematically illustrates a wireless network 900 in accordance with various embodiments. The wireless network 900 may include a UE 902 in wireless communication with an AN 904. The UE 902 and AN 904 may be similar to, and substantially interchangeable with, like-named components described elsewhere herein.

The UE 902 may be communicatively coupled with the AN 904 via connection 906. The connection 906 is illustrated as an air interface to enable communicative coupling, and can be consistent with cellular communications protocols such as an LTE protocol or a 5G NR protocol operating at mm Wave or sub-6 GHZ frequencies.

The UE 902 may include a host platform 908 coupled with a modem platform 910. The host platform 908 may include application processing circuitry 912, which may be coupled with protocol processing circuitry 914 of the modem platform 910. The application processing circuitry 912 may run various applications for the UE 902 that source/sink application data. The application processing circuitry 912 may further implement one or more layer operations to transmit/receive application data to/from a data network. These layer operations may include transport (for example UDP) and Internet (for example, IP) operations

The protocol processing circuitry 914 may implement one or more of layer operations to facilitate transmission or reception of data over the connection 906. The layer operations implemented by the protocol processing circuitry 914 may include, for example, MAC, RLC, PDCP, RRC and NAS operations.

The modem platform 910 may further include digital baseband circuitry 916 that may implement one or more layer operations that are “below” layer operations performed by the protocol processing circuitry 914 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 910 may further include transmit circuitry 918, receive circuitry 920, RF circuitry 922, and RF front end (RFFE) 924, which may include or connect to one or more antenna panels 926. Briefly, the transmit circuitry 918 may include a digital-to-analog converter, mixer, intermediate frequency (IF) components, etc.; the receive circuitry 920 may include an analog-to-digital converter, mixer, IF components, etc.; the RF circuitry 922 may include a low-noise amplifier, a power amplifier, power tracking components, etc.; RFFE 924 may include filters (for example, surface/bulk acoustic wave filters), switches, antenna tuners, beamforming components (for example, phase-array antenna components), etc. The selection and arrangement of the components of the transmit circuitry 918, receive circuitry 920, RF circuitry 922, RFFE 924, and antenna panels 926 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 914 may include one or more instances of control circuitry (not shown) to provide control functions for the transmit/receive components.

A UE reception may be established by and via the antenna panels 926, RFFE 924, RF circuitry 922, receive circuitry 920, digital baseband circuitry 916, and protocol processing circuitry 914. In some embodiments, the antenna panels 926 may receive a transmission from the AN 904 by receive-beamforming signals received by a plurality of antennas/antenna elements of the one or more antenna panels 926.

A UE transmission may be established by and via the protocol processing circuitry 914, digital baseband circuitry 916, transmit circuitry 918, RF circuitry 922, RFFE 924, and antenna panels 926. In some embodiments, the transmit components of the UE 904 may apply a spatial filter to the data to be transmitted to form a transmit beam emitted by the antenna elements of the antenna panels 926.

Similar to the UE 902, the AN 904 may include a host platform 928 coupled with a modem platform 930. The host platform 928 may include application processing circuitry 932 coupled with protocol processing circuitry 934 of the modem platform 930. The modem platform may further include digital baseband circuitry 936, transmit circuitry 938, receive circuitry 940, RF circuitry 942, RFFE circuitry 944, and antenna panels 946. The components of the AN 904 may be similar to and substantially interchangeable with like-named components of the UE 902. In addition to performing data transmission/reception as described above, the components of the AN 908 may perform various logical functions that include, for example, RNC functions such as radio bearer management, uplink and downlink dynamic radio resource management, and data packet scheduling.

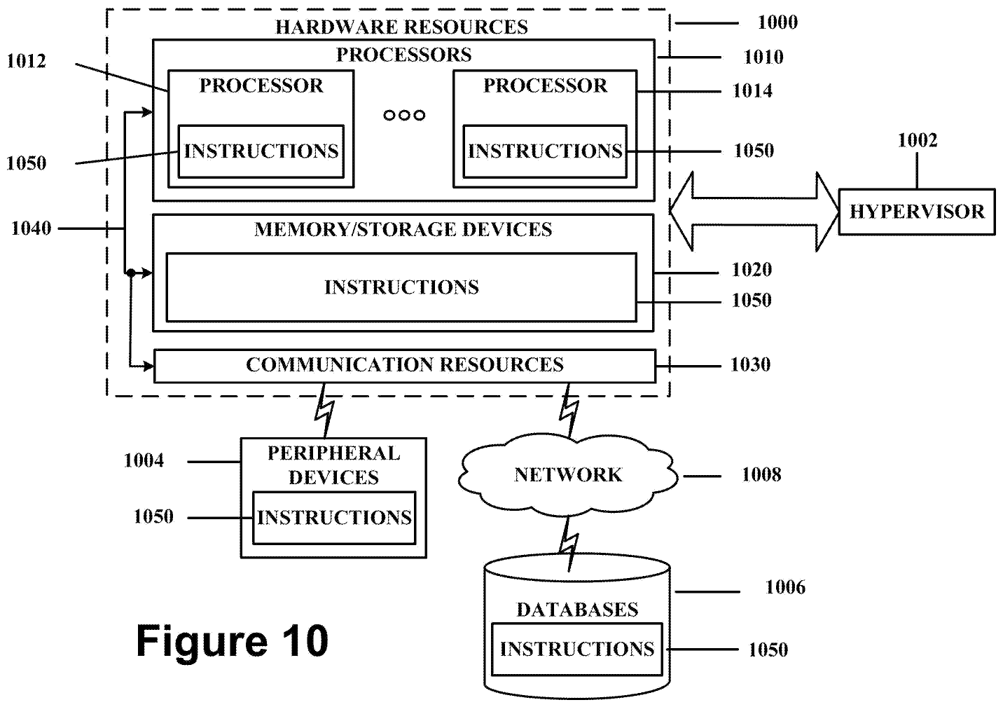

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040 or other interface circuitry. For embodiments where node virtualization (e.g., NFV) is utilized, a hypervisor 1002 may be executed to provide an execution environment for one or more network slices/sub-slices to utilize the hardware resources 1000.

The processors 1010 may include, for example, a processor 1012 and a processor 1014. The processors 1010 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1020 may include main memory, disk storage, or any suitable combination thereof. The memory/storage devices 1020 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1030 may include interconnection or network interface controllers, components, or other suitable devices to communicate with one or more peripheral devices 1004 or one or more databases 1006 or other network elements via a network 1008. For example, the communication resources 1030 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

### Example Procedures

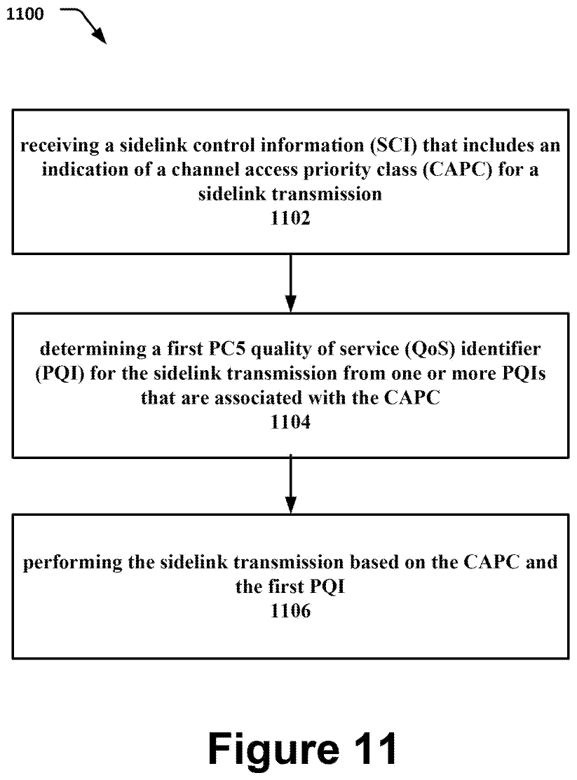

In some embodiments, the electronic device(s), network(s), system(s), chip(s) or component(s), or portions or implementations thereof, of FIGS. 8-10, or some other figure herein, may be configured to perform one or more processes, techniques, or methods as described herein, or portions thereof. One such process 1100 is depicted in FIG. 11. The process 1100 may be performed by a user equipment (UE), one or more elements of a UE, or an electronic device that includes a UE. At 1102, the process 1100 may include receiving a sidelink control information (SCI) that includes an indication of a channel access priority class (CAPC) for a sidelink transmission. At 1104, the process 1100 may further include determining a first PC5 quality of service (QOS) identifier (PQI) for the sidelink transmission from one or more PQIs that are associated with the CAPC. At 1106, the process 1100 may further include performing the sidelink transmission based on the CAPC and the first PQI.

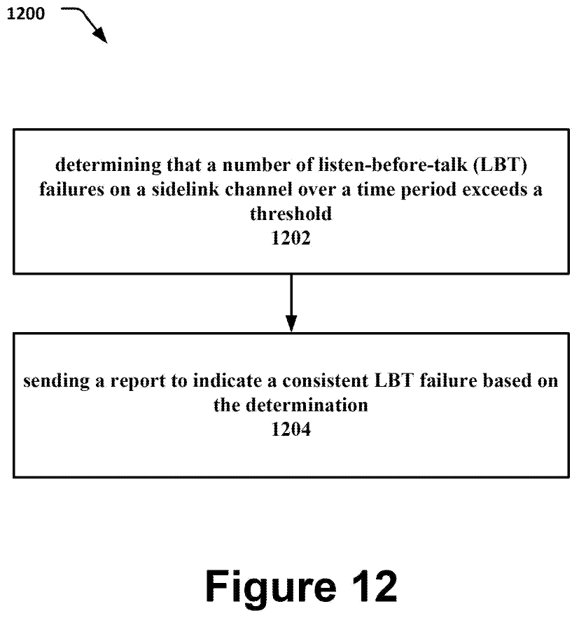

FIG. 12 illustrates another example process 1200 in accordance with various embodiments. The process 1200 may be performed by a UE, one or more elements of a UE, or an electronic device that includes a UE. At 1202, the process 1200 may include determining that a number of listen-before-talk (LBT) failures on a sidelink channel over a time period exceeds a threshold. At 1204, the process 1200 may further include sending a report to indicate a consistent LBT failure based on the determination.

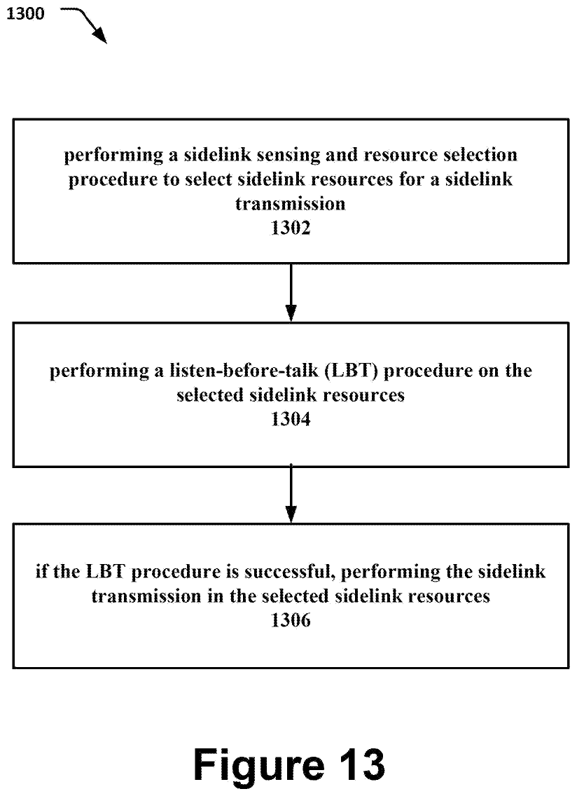

FIG. 13 illustrates another example process 1300 in accordance with various embodiments. The process 1300 may be performed by a UE, one or more elements of a UE, or an electronic device that includes a UE. At 1302, the process 1300 may include performing a sidelink sensing and resource selection procedure to select sidelink resources for a sidelink transmission. At 1304, the process 1300 may further include performing a listen-before-talk (LBT) procedure on the selected sidelink resources. At 1306, the process 1300 may further include, if the LBT procedure is successful, performing the sidelink transmission in the selected sidelink resources.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example A1 may include one or more non-transitory computer-readable media (NTCRM) having instructions, stored thereon, that when executed by one or more processors of a user equipment (UE) configure the UE to:
receive a sidelink control information (SCI) that includes an indication of a channel access priority class (CAPC) for a sidelink transmission;
determine a first PC5 quality of service (QOS) identifier (PQI) for the sidelink transmission from one or more PQIs that are associated with the CAPC; and
perform the sidelink transmission based on the CAPC and the first PQI.

Example A2 may include the one or more NTCRM of example A1, wherein the instructions when executed, are further to configure the UE to:
determine a maximum channel occupancy time for the sidelink transmission based on the CAPC; and
determine one or more QoS characteristics for the sidelink transmission based on the first PQI

Example A3 may include the one or more NTCRM of example A1, wherein the first PQI is determined based on an association between PQIs and corresponding CAPCs according to:

| Channel Access Priority Class ( ) | P Qos control indicator (QCI)/PQI |
|---|---|
| 1 | 1, 3, 5, 65, 66, 69, 70, 21, |
| | 22, 55, 56, 57, 90, 91 |
| 2 | 2, 7, 23, 58 |
| 3 | 4, 6, 8, 9, 59 |
| 4 | — |

Example A4 may include the one or more NTCRM of any one of examples A1-A3, wherein the SCI further includes an indication of a ProSe per packet priority (PPPP) for the sidelink transmission, wherein the sidelink transmission is performed further based on the PPPP.

Example A5 may include the one or more NTCRM of example A4, wherein the instructions, when executed, are further to configure the UE to:
determine a sidelink transmission priority for the sidelink transmission based on the PPPP; and
perform a sidelink sensing and resource selection procedure for the sidelink transmission based on the sidelink transmission priority.

Example A6 may include the one or more NTCRM of example A5, wherein the instructions, when executed, further configure the UE to determine a listen-before-talk (LBT)-based sidelink channel access procedure for the sidelink transmission based on the CAPC.

Example A7 may include the one or more NTCRM of any one of examples A1-A3, wherein the SCI does not indicate a ProSe per packet priority (PPPP) for the sidelink transmission or a PPPP indicated by the SCI is ignored for the sidelink transmission.

Example A8 may include one or more non-transitory computer-readable media (NTCRM) having instructions, stored thereon, that when executed by one or more processors of a user equipment (UE) configure the UE to:
determine that a number of listen-before-talk (LBT) failures on a sidelink channel over a time period exceed a threshold; and
send a report to indicate a consistent LBT failure based on the determination.

Example A9 may include the one or more NTCRM of example A8, wherein the UE is in a sidelink mode 1.

Example A10 may include the one or more NTCRM of example A8, wherein the UE is in a sidelink mode 2.

Example A11 may include the one or more NTCRM of example A8, wherein the report is sent to a gNB.

Example A12 may include the one or more NTCRM of any one of examples A8-A11, wherein the determination is associated with an attempted transmission of a physical sidelink feedback channel (PSFCH) by the UE.

Example A13 may include one or more non-transitory computer-readable media (NTCRM) having instructions, stored thereon, that when executed by one or more processors of a user equipment (UE) configure the UE to:
perform a sidelink sensing and resource selection procedure to select sidelink resources for a sidelink transmission;
perform a listen-before-talk (LBT) procedure on the selected sidelink resources; and
if the LBT procedure is successful, perform the sidelink transmission in the selected sidelink resources.

Example A14 may include the one or more NTCRM of example A13, wherein the sidelink sensing and resource selection procedure is performed based on an energy detection threshold of the LBT procedure.

Example A15 may include the one or more NTCRM of example A13, wherein the sidelink sensing and resource selection procedure includes to sense for activity on resources of a channel and exclude one or more of the resources from a set of candidate resources based on the sensed activity, wherein the sidelink resources for the sidelink transmission are selected from the set of candidate resources.

Example A16 may include the one or more NTCRM of example A13, wherein the LBT procedure is performed within a cyclic prefix extension prior to the selected sidelink resources.

Example A17 may include the one or more NTCRM of example A13, wherein the selected sidelink resources include contiguous slots.

Example A18 may include the one or more NTCRM of example A17, wherein the instructions, when executed, further configure the UE to determine that selection of the contiguous slots is supported based on one or more conditions.

Example A19 may include the one or more NTCRM of example A18, wherein the one or more conditions include one or more of:
a packet delay budget of less than a first predetermined value;
a remaining packet delay budget of less than a second predetermined value;
a channel busy ratio (CBR) of less than a third predetermined value; or
a condition based on a priority or channel access priority condition (CAPC) of the sidelink transmission.

Example A20 may include the one or more NTCRM of any one of examples A13-A19, wherein the sidelink sensing and resource selection procedure is to prioritize resources that are earliest in time.

Example B1 may include a method to enable a SL system to operate in unlicensed spectrum.

Example B2 may include the method of example B1 or some other example herein, further comprising a LBT and the Sensing and Resource (re)-selection procedure in a SL system operating in unlicensed spectrum.

Example B3 may include the method of example B1 or some other example herein, further comprising enhancements to the Resource (re)-selection procedure in a SL system operating in unlicensed spectrum.

Example B4 may include the method of example B1 or some other example herein, further comprising a method to allow resource selection of back-to-back resources in a SL system operating in unlicensed spectrum.

Example B5 may include the method of example B1 or some other example herein, further comprising a method to allow transmission on reserved non-utilized resources in a SL system operating in unlicensed spectrum.

Example B6 may include a method of a UE, the method comprising: performing a sidelink sensing and resource selection procedure to select sidelink resources for transmission based on a listen-before-talk (LBT) threshold of a LBT procedure; and performing the transmission in the selected sidelink resources.

Example B7 may include the method of example B6 or some other example herein, wherein the LBT procedure is performed on the selected sidelink resources prior to the transmission.

Example C1 may include a method to handle LBT failures in a SL system operating in mode 1 in unlicensed band.

Example C2 may include a method to handle LBT failures in a SL system operating in mode 2 in unlicensed band.

Example C3 may include a method to request in a SL system operating in mode 1 in unlicensed band another UE to initiate and share a SL COT interval.

Example C4 may include a method to request in a SL system operating in mode 2 in unlicensed band another UE to initiate and share a SL COT interval.

Examples C5 may include a method to map and relate SL Priorities and CAPCs within a SL system operating in unlicensed band.

Example C6 may include a method of a UE, the method comprising: determining that a number of listen-before-talk (LBT) failures on a sidelink channel exceed a threshold; and sending a report to indicate a consistent LBT failure based on the determination.

Example C7 may include the method of example C6 or some other example herein, wherein the UE is in a sidelink mode 1.

Example C8 may include the method of example C6 or some other example herein, wherein the UE is in a sidelink mode 2.

Example C9 may include the method of example C6-C8 or some other example herein, wherein the report is sent to a gNB.

Example C10 may include the method of example C6-C9 or some other example herein, wherein the determination is associated with an attempted transmission of a sidelink message by the UE.

Example C11 may include the method of example C10 or some other example herein, wherein the sidelink message is a PSCCH, PSSCH, PSFCH, PSBCH, and/or S-SSB.

Example Z01 may include an apparatus comprising means to perform one or more elements of a method described in or related to any of examples A1-A20, B1-B7, C1-C11, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples A1-A20, B1-B7, C1-C11, or any other method or process described herein.

Example Z03 may include an apparatus comprising logic, modules, or circuitry to perform one or more elements of a method described in or related to any of examples A1-A20, B1-B7, C1-C11, or any other method or process described herein.

Example Z04 may include a method, technique, or process as described in or related to any of examples A1-A20, B1-B7, C1-C11, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples A1-A20, B1-B7, C1-C11, or portions thereof. Example Z06 may include a signal as described in or related to any of examples A1-A20, B1-B7, C1-C11, or portions or parts thereof.

Example Z07 may include a datagram, packet, frame, segment, protocol data unit (PDU), or message as described in or related to any of examples A1-A20, B1-B7, C1-C11, or portions or parts thereof, or otherwise described in the present disclosure.

Example Z08 may include a signal encoded with data as described in or related to any of examples A1-A20, B1-B7, C1-C11, or portions or parts thereof, or otherwise described in the present disclosure.

Example Z09 may include a signal encoded with a datagram, packet, frame, segment, protocol data unit (PDU), or message as described in or related to any of examples A1-A20, B1-B7, C1-C11, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples A1-A20, B1-B7, C1-C11, or portions thereof.

Example Z11 may include a computer program comprising instructions, wherein execution of the program by a processing element is to cause the processing element to carry out the method, techniques, or process as described in or related to any of examples A1-A20, B1-B7, C1-C11, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | |
|---|---|
| 3GPP | Third Generation Partnership Project |
| 4G | Fourth Generation |
| 5G | Fifth Generation |
| 5GC | 5G Core network |
| AC | Application Client |
| ACR | Application Context Relocation |
| ACK | Acknowledgement |
| ACID | Application Client Identification |
| AF | Application Function |
| AM | Acknowledged Mode |
| AMBR | Aggregate Maximum Bit Rate |
| AMF | Access and Mobility Management Function |
| AN | Access Network |
| ANR | Automatic Neighbour Relation |
| AOA | Angle of Arrival |
| AP | Application Protocol, Antenna Port, Access Point |
| API | Application Programming Interface |
| APN | Access Point Name |
| ARP | Allocation and Retention Priority |
| ARQ | Automatic Repeat Request |
| AS | Access Stratum |
| ASP | Application Service Provider |
| ASN.1 | Abstract Syntax Notation One |
| AUSF | Authentication Server Function |
| AWGN | Additive White Gaussian Noise |
| BAP | Backhaul Adaptation Protocol |
| BCH | Broadcast Channel |
| BER | Bit Error Ratio |
| BFD | Beam Failure Detection |
| BLER | Block Error Rate |
| BPSK | Binary Phase Shift Keying |
| BRAS | Broadband Remote Access Server |
| BSS | Business Support System |
| BS | Base Station |
| BSR | Buffer Status Report |
| BW | Bandwidth |
| BWP | Bandwidth Part |
| C-RNTI | Cell Radio Network Temporary Identity |
| CA | Carrier Aggregation, Certification Authority |
| CAPEX | CAPital EXpenditure |
| CBRA | Contention Based Random Access |
| CC | Component Carrier, Country Code, Cryptographic |
| | Checksum |
| CCA | Clear Channel Assessment |
| CCE | Control Channel Element |
| CCCH | Common Control Channel |
| CE | Coverage Enhancement |
| CDM | Content Delivery Network |
| CDMA | Code-Division Multiple Access |
| CDR | Charging Data Request |
| CDR | Charging Data Response |
| CFRA | Contention Free Random Access |
| CG | Cell Group |
| CGF | Charging Gateway Function |
| CHF | Charging Function |
| CI | Cell Identity |
| CID | Cell-ID (e.g., positioning method) |
| CIM | Common Information Model |
| CIR | Carrier to Interference Ratio |
| CK | Cipher Key |
| CM | Connection Management, Conditional Mandatory |
| CMAS | Commercial Mobile Alert Service |
| CMD | Command |
| CMS | Cloud Management System |
| CO | Conditional Optional |
| CoMP | Coordinated Multi-Point |
| CORESET | Control Resource Set |
| COTS | Commercial Off-The-Shelf |
| CP | Control Plane, Cyclic Prefix, Connection Point |
| CPD | Connection Point Descriptor |
| CPE | Customer Premise Equipment |
| CPICH | Common Pilot Channel |
| CQI | Channel Quality Indicator |
| CPU | CSI processing unit, Central Processing Unit |
| C/R | Command/Response field bit |
| CRAN | Cloud Radio Access Network, Cloud RAN |
| CRB | Common Resource Block |
| CRC | Cyclic Redundancy Check |
| CRI | Channel-State Information Resource Indicator, CSI-RS |
| | Resource Indicator |
| C-RNTI | Cell RNTI |
| CS | Circuit Switched |
| CSCF | call session control function |
| CSAR | Cloud Service Archive |
| CSI | Channel-State Information |
| CSI-IM | CSI Interference Measurement |
| CSI-RS | CSI Reference Signal |
| CSI-RSRP | CSI reference signal received power |
| CSI-RSRQ | CSI reference signal received quality |
| CSI-SINR | CSI signal-to-noise and interference ratio |
| CSMA | Carrier Sense Multiple Access |
| CSMA/CA | CSMA with collision avoidance |
| CSS | Common Search Space, Cell-specific Search Space |
| CTF | Charging Trigger Function |
| CTS | Clear-to-Send |
| CW | Codeword |
| CWS | Contention Window Size |
| D2D | Device-to-Device |
| DC | Dual Connectivity, Direct Current |
| DCI | Downlink Control Information |
| DF | Deployment Flavour |
| DL | Downlink |
| DMTF | Distributed Management Task Force |
| DPDK | Data Plane Development Kit |
| DM-RS, | Demodulation Reference Signal |
| DMRS | |
| DN | Data network |
| DNN | Data Network Name |
| DNAI | Data Network Access Identifier |
| DRB | Data Radio Bearer |
| DRS | Discovery Reference Signal |
| DRX | Discontinuous Reception |
| DSL | Domain Specific Language, Digital Subscriber Line |
| DSLAM | DSL Access Multiplexer |
| DwPTS | Downlink Pilot Time Slot |
| E-LAN | Ethernet Local Area Network |
| E2E | End-to-End |
| EAS | Edge Application Server |
| ECCA | extended clear channel assessment, extended CCA |
| ECCE | Enhanced Control Channel Element, Enhanced CCE |
| ED | Energy Detection |
| EDGE | Enhanced Datarates for GSM Evolution (GSM |
| | Evolution) |
| EAS | Edge Application Server |
| EASID | Edge Application Server Identification |
| ECS | Edge Configuration Server |
| ECSP | Edge Computing Service Provider |
| EDN | Edge Data Network |
| EEC | Edge Enabler Client |
| EECID | Edge Enabler Client Identification |
| EES | Edge Enabler Server |
| EESID | Edge Enabler Server Identification |
| EHE | Edge Hosting Environment |
| EGMF | Exposure Governance Management Function |
| EGPRS | Enhanced GPRS |
| EIR | Equipment Identity Register |
| eLAA | enhanced Licensed Assisted Access, enhanced LAA |
| EM | Element Manager |
| eMBB | Enhanced Mobile Broadband |
| EMS | Element Management System |
| eNB | evolved NodeB, E-UTRAN Node B |
| EN-DC | E-UTRA-NR Dual Connectivity |
| EPC | Evolved Packet Core |
| EPDCCH | enhanced PDCCH, enhanced Physical Downlink |
| | Control Cannel |
| EPRE | Energy per resource element |
| EPS | Evolved Packet System |
| EREG | enhanced REG, enhanced resource element groups |
| ETSI | European Telecommunications Standards Institute |
| ETWS | Earthquake and Tsunami Warning System |
| eUICC | embedded UICC, embedded Universal Integrated |
| | Circuit Card |
| E-UTRA | Evolved UTRA |
| E-UTRAN | Evolved UTRAN |
| EV2X | Enhanced V2X |
| F1AP | F1 Application Protocol |
| F1-C | F1 Control plane interface |
| F1-U | F1 User plane interface |
| FACCH | Fast Associated Control CHannel |
| FACCH/F | Fast Associated Control Channel/Full rate |
| FACCH/H | Fast Associated Control Channel/Half rate |
| FACH | Forward Access Channel |
| FAUSCH | Fast Uplink Signalling Channel |
| FB | Functional Block |
| FBI | Feedback Information |
| FCC | Federal Communications Commission |
| FCCH | Frequency Correction CHannel |
| FDD | Frequency Division Duplex |
| FDM | Frequency Division Multiplex |
| FDMA | Frequency Division Multiple Access |
| FE | Front End |
| FEC | Forward Error Correction |
| FFS | For Further Study |
| FFT | Fast Fourier Transformation |
| feLAA | further enhanced Licensed Assisted Access, |
| | further enhanced LAA |
| FN | Frame Number |
| FPGA | Field-Programmable Gate Array |
| FR | Frequency Range |
| FQDN | Fully Qualified Domain Name |
| G-RNTI | GERAN Radio Network Temporary Identity |
| GERAN | GSM EDGE RAN, GSM EDGE |
| | Radio Access Network |
| GGSN | Gateway GPRS Support Node |
| GLONASS | GLObal'naya NAvigatsionnaya Sputnikovaya |
| | Sistema (Engl.: Global Navigation Satellite |
| | System) |
| gNB | Next Generation NodeB |
| gNB-CU | gNB-centralized unit, Next Generation NodeB |
| | centralized unit |
| gNB-DU | gNB-distributed unit, Next Generation NodeB |
| | distributed unit |
| GNSS | Global Navigation Satellite System |
| GPRS | General Packet Radio Service |
| GPSI | Generic Public Subscription Identifier |
| GSM | Global System for Mobile Communications, Groupe |
| | Spécial Mobile |
| GTP | GPRS Tunneling Protocol |
| GTP-UGPRS | Tunnelling Protocol for User Plane |
| GTS | Go To Sleep Signal (related to WUS) |
| GUMMEI | Globally Unique MME Identifier |
| GUTI | Globally Unique Temporary UE Identity |
| HARQ | Hybrid ARQ, Hybrid Automatic Repeat Request |
| HANDO | Handover |
| HFN | HyperFrame Number |
| HHO | Hard Handover |
| HLR | Home Location Register |
| HN | Home Network |
| HO | Handover |
| HPLMN | Home Public Land Mobile Network |
| HSDPA | High Speed Downlink Packet Access |
| HSN | Hopping Sequence Number |
| HSPA | High Speed Packet Access |
| HSS | Home Subscriber Server |
| HSUPA | High Speed Uplink Packet Access |
| HTTP | Hyper Text Transfer Protocol |
| HTTPS | Hyper Text Transfer Protocol Secure (https is |
| | http/1.1 over SSL, i.e. port 443) |
| I-Block | Information Block |
| ICCID | Integrated Circuit Card Identification |
| IAB | Integrated Access and Backhaul |
| ICIC | Inter-Cell Interference Coordination |
| ID | Identity, identifier |
| IDFT | Inverse Discrete Fourier Transform |
| IE | Information element |
| IBE | In-Band Emission |
| IEEE | Institute of Electrical and Electronics Engineers |
| IEI | Information Element Identifier |
| IEIDL | Information Element Identifier Data Length |
| IETF | Internet Engineering Task Force |
| IF | Infrastructure |
| IIOT | Industrial Internet of Things |
| IM | Interference Measurement, Intermodulation, IP |
| | Multimedia |
| IMC | IMS Credentials |
| IMEI | International Mobile Equipment Identity |
| IMGI | International mobile group identity |
| IMPI | IP Multimedia Private Identity |
| IMPU | IP Multimedia PUblic identity |
| IMS | IP Multimedia Subsystem |
| IMSI | International Mobile Subscriber Identity |
| IoT | Internet of Things |
| IP | Internet Protocol |
| Ipsec | IP Security, Internet Protocol Security |
| IP-CAN | IP-Connectivity Access Network |
| IP-M | IP Multicast |
| IPV4 | Internet Protocol Version 4 |
| IPV6 | Internet Protocol Version 6 |
| IR | Infrared |
| IS | In Sync |
| IRP | Integration Reference Point |
| ISDN | Integrated Services Digital Network |
| ISIM | IM Services Identity Module |
| ISO | International Organisation for Standardisation |
| ISP | Internet Service Provider |
| IWF | Interworking-Function |
| I-WLAN | Interworking WLAN Constraint length of the |
| | convolutional code, USIM Individual key |
| kB | Kilobyte (1000 bytes) |
| kbps | kilo-bits per second |
| Kc | Ciphering key |
| Ki | Individual subscriber authentication key |
| KPI | Key Performance Indicator |
| KQI | Key Quality Indicator |
| KSI | Key Set Identifier |
| ksps | kilo-symbols per second |
| KVM | Kernel Virtual Machine |
| L1 | Layer 1 (physical layer) |
| L1-RSRP | Layer 1 reference signal received power |
| L2 | Layer 2 (data link layer) |
| L3 | Layer 3 (network layer) |
| LAA | Licensed Assisted Access |
| LAN | Local Area Network |
| LADN | Local Area Data Network |
| LBT | Listen Before Talk |
| LCM | LifeCycle Management |
| LCR | Low Chip Rate |
| LCS | Location Services |
| LCID | Logical Channel ID |
| LI | Layer Indicator |
| LLC | Logical Link Control, Low Layer Compatibility |
| LMF | Location Management Function |
| LOS | Line of Sight |
| LPLMN | Local PLMN |
| LPP | LTE Positioning Protocol |
| LSB | Least Significant Bit |
| LTE | Long Term Evolution |
| LWA | LTE-WLAN aggregation |
| LWIP | LTE/WLAN Radio Level Integration with IPsec Tunnel |
| LTE | Long Term Evolution |
| M2M | Machine-to-Machine |
| MAC | Medium Access Control (protocol layering context) |
| MAC | Message authentication code (security/encryption |
| | context) |
| MAC-A | MAC used for authentication and key agreement |
| | (TSG T WG3 context) |
| MAC-IMAC | used for data integrity of signalling messages |
| | (TSG T WG3 context) |
| MANO | Management and Orchestration |
| MBMS | Multimedia Broadcast and Multicast Service |
| MBSFN | Multimedia Broadcast multicast service Single |
| | Frequency Network |
| MCC | Mobile Country Code |
| MCG | Master Cell Group |
| MCOT | Maximum Channel Occupancy Time |
| MCS | Modulation and coding scheme |
| MDAF | Management Data Analytics Function |
| MDAS | Management Data Analytics Service |
| MDT | Minimization of Drive Tests |
| ME | Mobile Equipment |
| MeNB | master eNB |
| MER | Message Error Ratio |
| MGL | Measurement Gap Length |
| MGRP | Measurement Gap Repetition Period |
| MIB | Master Information Block, Management Information |
| | Base |
| MIMO | Multiple Input Multiple Output |
| MLC | Mobile Location Centre |
| MM | Mobility Management |
| MME | Mobility Management Entity |
| MN | Master Node |
| MNO | Mobile Network Operator |
| MO | Measurement Object, Mobile Originated |
| MPBCH | MTC Physical Broadcast CHannel |
| MPDCCH | MTC Physical Downlink Control CHannel |
| MPDSCH | MTC Physical Downlink Shared CHannel |
| MPRACH | MTC Physical Random Access CHannel |
| MPUSCH | MTC Physical Uplink Shared Channel |
| MPLS | MultiProtocol Label Switching |
| MS | Mobile Station |
| MSB | Most Significant Bit |
| MSC | Mobile Switching Centre |
| MSI | Minimum System Information, MCH Scheduling |
| | Information |
| MSID | Mobile Station Identifier |
| MSIN | Mobile Station Identification Number |
| MSISDN | Mobile Subscriber ISDN Number |
| MT | Mobile Terminated, Mobile Termination |
| MTC | Machine-Type Communications |
| mMTCmassive | MTC, massive Machine-Type Communications |
| MU-MIMO | Multi User MIMO |
| MWUS | MTC wake-up signal, MTC WUS |
| NACK | Negative Acknowledgement |
| NAI | Network Access Identifier |
| NAS | Non-Access Stratum, Non-Access Stratum layer |
| NCT | Network Connectivity Topology |
| NC-JT | Non-Coherent Joint Transmission |
| NEC | Network Capability Exposure |
| NE-DC | NR-E-UTRA Dual Connectivity |
| NEF | Network Exposure Function |
| NF | Network Function |
| NFP | Network Forwarding Path |
| NFPD | Network Forwarding Path Descriptor |
| NFV | Network Functions Virtualization |
| NFVI | NFV Infrastructure |
| NFVO | NFV Orchestrator |
| NG | Next Generation, Next Gen |
| NGEN-DC | NG-RAN E-UTRA-NR Dual Connectivity |
| NM r | Network Manage |
| NMS | Network Management System |
| N-PoP | Network Point of Presence |
| NMIB, N-MIB | Narrowband MIB |
| NPBCH | Narrowband Physical Broadcast CHannel |
| NPDCCH | Narrowband Physical Downlink Control CHannel |
| NPDSCH | Narrowband Physical Downlink Shared CHannel |
| NPRACH | Narrowband Physical Random Access CHannel |
| NPUSCH | Narrowband Physical Uplink Shared CHannel |
| NPSS | Narrowband Primary Synchronization Signal |
| NSSS | Narrowband Secondary Synchronization Signal |
| NR | New Radio, Neighbour Relation |
| NRF | NF Repository Function |
| NRS | Narrowband Reference Signal |
| NS | Network Service |
| NSA | Non-Standalone operation mode |
| NSD | Network Service Descriptor |
| NSR | Network Service Record |
| NSSAI | Network Slice Selection Assistance Information |
| S-NNSAI | Single-NSSAI |
| NSSF | Network Slice Selection Function |
| NW | Network |
| NWUS | Narrowband wake-up signal, Narrowband WUS |
| NZP | Non-Zero Power |
| O&M | Operation and Maintenance |
| ODU2 | Optical channel Data Unit - type 2 |
| OFDM | Orthogonal Frequency Division Multiplexing |
| OFDMA | Orthogonal Frequency Division Multiple Access |
| OOB | Out-of-band |
| OOS | Out of Sync |
| OPEX | OPerating EXpense |
| OSI | Other System Information |
| OSS | Operations Support System |
| OTA | over-the-air |
| PAPR | Peak-to-Average Power Ratio |
| PAR | Peak to Average Ratio |
| PBCH | Physical Broadcast Channel |
| PC | Power Control, Personal Computer |
| PCC | Primary Component Carrier, Primary CC |
| P-CSCF | Proxy CSCF |
| PCell | Primary Cell |
| PCI | Physical Cell ID, Physical Cell Identity |
| PCEF | Policy and Charging Enforcement Function |
| PCF | Policy Control Function |
| PCRF | Policy Control and Charging Rules Function |
| PDCP | Packet Data Convergence Protocol, Packet Data |
| | Convergence Protocol layer |
| PDCCH | Physical Downlink Control Channel |
| PDCP | Packet Data Convergence Protocol |
| PDN | Packet Data Network, Public Data Network |
| PDSCH | Physical Downlink Shared Channel |
| PDU | Protocol Data Unit |
| PEI | Permanent Equipment Identifiers |
| PFD | Packet Flow Description |
| P-GW | PDN Gateway |
| PHICH | Physical hybrid-ARQ indicator channel |
| PHY | Physical layer |
| PLMN | Public Land Mobile Network |
| PIN | Personal Identification Number |
| PM | Performance Measurement |
| PMI | Precoding Matrix Indicator |
| PNF | Physical Network Function |
| PNFD | Physical Network Function Descriptor |
| PNFR | Physical Network Function Record |
| POC | PTT over Cellular |
| PP, PTP | Point-to-Point |
| PPP | Point-to-Point Protocol |
| PRACH | Physical RACH |
| PRB | Physical resource block |
| PRG | Physical resource block group |
| ProSe | Proximity Services, Proximity-Based Service |
| PRS | Positioning Reference Signal |
| PRR | Packet Reception Radio |
| PS | Packet Services |
| PSBCH | Physical Sidelink Broadcast Channel |
| PSDCH | Physical Sidelink Downlink Channel |
| PSCCH | Physical Sidelink Control Channel |
| PSSCH | Physical Sidelink Shared Channel |
| PSFCH | physical sidelink feedback channel |
| PSCell | Primary SCell |
| PSS | Primary Synchronization Signal |
| PSTN | Public Switched Telephone Network |
| PT-RS | Phase-tracking reference signal |
| PTT | Push-to-Talk |
| PUCCH | Physical Uplink Control Channel |
| PUSCH | Physical Uplink Shared Channel |
| QAM | Quadrature Amplitude Modulation |
| QCI | QoS class of identifier |
| QCL | Quasi co-location |
| QFI | QoS Flow ID, QoS Flow Identifier |
| QoS | Quality of Service |
| QPSK | Quadrature (Quaternary) Shift Keying |
| QZSS | Quasi-Zenith Satellite System |
| RA-RNTI | Random Access RNTI |
| RAB | Radio Access Bearer, Random Access Burst |
| RACH | Random Access Channel |
| RADIUS | Remote Authentication Dial In User Service |
| RAN | Radio Access Network |
| RAND | RANDom number (used for authentication) |
| RAR | Random Access Response |
| RAT | Radio Access Technology |
| RAU | Routing Area Update |
| RB | Resource block, Radio Bearer |
| RBG | Resource block group |
| REG | Resource Element Group |
| Rel | Release |
| REQ | REQuest |
| RF | Radio Frequency |
| RI | Rank Indicator |
| RIV | Resource indicator value |
| RL | Radio Link |
| RLC | Radio Link Control, Radio Link Control layer |
| RLC AM | RLC Acknowledged Mode |
| RLC UM | RLC Unacknowledged Mode |
| RLF | Radio Link Failure |
| RLM | Radio Link Monitoring |
| RLM-RS | Reference Signal for RLM |
| RM | Registration Management |
| RMC | Reference Measurement Channel |
| RMSI | Remaining MSI, Remaining Minimum System |
| | Information |
| RN | Relay Node |
| RNC | Radio Network Controller |
| RNL | Radio Network Layer |
| RNTI | Radio Network Temporary Identifier |
| ROHC | RObust Header Compression |
| RRC | Radio Resource Control, Radio Resource Control layer |
| RRM | Radio Resource Management |
| RS | Reference Signal |
| RSRP | Reference Signal Received Power |
| RSRQ | Reference Signal Received Quality |
| RSSI | Received Signal Strength Indicator |
| RSU | Road Side Unit |
| RSTD | Reference Signal Time difference |
| RTP | Real Time Protocol |
| RTS | Ready-To-Send |
| RTT | Round Trip Time |
| Rx | Reception, Receiving, Receiver |
| S1AP | S1 Application Protocol |
| S1-MME | S1 for the control plane |
| S1-U | S1 for the user plane |
| S-CSCF | serving CSCF |
| S-GW | Serving Gateway |
| S-RNTI | SRNC Radio Network Temporary Identity |
| S-TMSI | SAE Temporary Mobile Station Identifier |
| SA | Standalone operation mode |
| SAE | System Architecture Evolution |
| SAP | Service Access Point |
| SAPD | Service Access Point Descriptor |
| SAPI | Service Access Point Identifier |
| SCC | Secondary Component Carrier, Secondary CC |
| SCell | Secondary Cell |
| SCEF | Service Capability Exposure Function |
| SC-FDMA | Single Carrier Frequency Division Multiple Access |
| SCG | Secondary Cell Group |
| SCM | Security Context Management |
| SCS | Subcarrier Spacing |
| SCTP | Stream Control Transmission Protocol |
| SDAP | Service Data Adaptation Protocol, Service Data |
| | Adaptation Protocol layer |
| SDL | Supplementary Downlink |
| SDNF | Structured Data Storage Network Function |
| SDP | Session Description Protocol |
| SDSF | Structured Data Storage Function |
| SDT | Small Data Transmission |
| SDU | Service Data Unit |
| SEAF | Security Anchor Function |
| SeNB | secondary eNB |
| SEPP | Security Edge Protection Proxy |
| SFI | Slot format indication |
| SFTD | Space-Frequency Time Diversity, SFN and frame |
| | timing difference |
| SFN | System Frame Number |
| SgNB | Secondary gNB |
| SGSN | Serving GPRS Support Node |
| S-GW | Serving Gateway |
| SI | System Information |
| SI-RNTI | System Information RNTI |
| SIB | System Information Block |
| SIM | Subscriber Identity Module |
| SIP | Session Initiated Protocol |
| SiP | System in Package |
| SL | Sidelink |
| SLA | Service Level Agreement |
| SM | Session Management |
| SMF | Session Management Function |
| SMS | Short Message Service |
| SMSF | SMS Function |
| SMTC | SSB-based Measurement Timing Configuration |
| SN | Secondary Node, Sequence Number |
| SoC | System on Chip |
| SON | Self-Organizing Network |
| SpCell | Special Cell |
| SP-CSI-RNTI | Semi-Persistent CSI RNTI |
| SPS | Semi-Persistent Scheduling |
| SQN | Sequence number |
| SR | Scheduling Request |
| SRB | Signalling Radio Bearer |
| SRS | Sounding Reference Signal |
| SS | Synchronization Signal |
| SSB | Synchronization Signal Block |
| SSID | Service Set Identifier |
| SS/PBCH | Block SSBRI SS/PBCH Block Resource Indicator, |
| | Synchronization Signal Block Resource Indicator |
| SSC | Session and Service Continuity |
| SS-RSRP | Synchronization Signal based Reference Signal |
| | Received Power |
| SS-RSRQ | Synchronization Signal based Reference Signal |
| | Received Quality |
| SS-SINR | Synchronization Signal based Signal to Noise and |
| | Interference Ratio |
| SSS | Secondary Synchronization Signal |
| SSSG | Search Space Set Group |
| SSSIF | Search Space Set Indicator |
| SST | Slice/Service Types |
| SU-MIMO | Single User MIMO |
| SUL | Supplementary Uplink |
| TA | Timing Advance, Tracking Area |
| TAC | Tracking Area Code |
| TAG | Timing Advance Group |
| TAI | Tracking Area Identity |
| TAU | Tracking Area Update |
| TB | Transport Block |
| TBS | Transport Block Size |
| TBD | To Be Defined |
| TCI | Transmission Configuration Indicator |
| TCP | Transmission Communication Protocol |
| TDD | Time Division Duplex |
| TDM | Time Division Multiplexing |
| TDMA | Time Division Multiple Access |
| TE | Terminal Equipment |
| TEID | Tunnel End Point Identifier |
| TFT | Traffic Flow Template |
| TMSI | Temporary Mobile Subscriber Identity |
| TNL | Transport Network Layer |
| TPC | Transmit Power Control |
| TPMI | Transmitted Precoding Matrix Indicator |
| TR | Technical Report |
| TRP, TRxP | Transmission Reception Point |
| TRS | Tracking Reference Signal |
| TRx | Transceiver |
| TS | Technical Specifications, Technical Standard |
| TTI | Transmission Time Interval |
| Tx | Transmission, Transmitting, Transmitter |
| U-RNTI | UTRAN Radio Network Temporary Identity |
| UART | Universal Asynchronous Receiver and Transmitter |
| UCI | Uplink Control Information |
| UE | User Equipment |
| UDM | Unified Data Management |
| UDP | User Datagram Protocol |
| UDSF | Unstructured Data Storage Network Function |
| UICC | Universal Integrated Circuit Card |
| UL | Uplink |
| UM | Unacknowledged Mode |
| UML | Unified Modelling Language |
| UMTS | Universal Mobile Telecommunications System |
| UP | User Plane |
| UPF | User Plane Function |
| URI | Uniform Resource Identifier |
| URL | Uniform Resource Locator |
| URLLC | Ultra-Reliable and Low Latency |
| USB | Universal Serial Bus |
| USIM | Universal Subscriber Identity Module |
| USS | UE-specific search space |
| UTRA | UMTS Terrestrial Radio Access |
| UTRAN | Universal Terrestrial Radio Access Network |
| UwPTS | Uplink Pilot Time Slot |
| V2I | Vehicle-to-Infrastruction |
| V2P | Vehicle-to-Pedestrian |
| V2V | Vehicle-to-Vehicle |
| V2X | Vehicle-to-everything |
| VIM | Virtualized Infrastructure Manager |
| VL | Virtual Link, |
| VLAN | Virtual LAN, Virtual Local Area Network |
| VM | Virtual Machine |
| VNF | Virtualized Network Function |
| VNFFG | VNF Forwarding Graph |
| VNFFGD | VNF Forwarding Graph Descriptor |
| VNFM | VNF Manager |
| VOIP | Voice-over-IP, Voice-over- Internet Protocol |
| VPLMN | Visited Public Land Mobile Network |
| VPN | Virtual Private Network |
| VRB | Virtual Resource Block |
| WiMAX | Worldwide Interoperability for Microwave Access |
| WLAN | Wireless Local Area Network |
| WMAN | Wireless Metropolitan Area Network |
| WPAN | Wireless Personal Area Network |
| X2-C | X2-Control plane |
| X2-U | X2-User plane |
| XML | eXtensible Markup Language |
| XRES | EXpected user RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-20. (canceled)

21. An apparatus for use in a user equipment (UE) comprising:
memory to store a received sidelink control information (SCI) that includes an indication of a channel access priority class (CAPC) for a sidelink transmission; and
one or more processors configured to:
determine a first PC5 quality of service (QOS) identifier (PQI) for the sidelink transmission from one or more PQIs that are associated with the CAPC; and
facilitate performance, by the UE, of the sidelink transmission based on the CAPC and the first PQI.

22. The apparatus of claim 21, wherein the one or more processors are further configured to:
determine a maximum channel occupancy time for the sidelink transmission based on the CAPC; and
determine one or more QoS characteristics for the sidelink transmission based on the first PQI.

23. The apparatus of claim 21, wherein the first PQI is determined based on an association between PQIs and corresponding CAPCs according to:

| Channel Access | QoS control indicator (QCI)/PQI |
|---|---|
| 1 | 1, 3, 5, 65, 66, 69, 70, 21, 22, 55, 56, |
| 2 | 2, 7, 23, 58 |
| 3 | 4, 6, 8, 9, 59 |
| 4 | — |

24. The apparatus of claim 21, wherein the SCI further includes an indication of a ProSe per packet priority (PPPP) for the sidelink transmission, wherein the sidelink transmission is performed further based on the PPPP.

25. The apparatus of claim 24, wherein the one or more processors are further configured to:
determine a sidelink transmission priority for the sidelink transmission based on the PPPP; and
perform a sidelink sensing and resource selection procedure for the sidelink transmission based on the sidelink transmission priority.

26. The apparatus of claim 25, wherein the one or more processors are further configured to determine a listen-before-talk (LBT)-based sidelink channel access procedure for the sidelink transmission based on the CAPC.

27. The apparatus of claim 21, wherein the SCI does not indicate a ProSe per packet priority (PPPP) for the sidelink transmission or a PPPP indicated by the SCI is ignored for the sidelink transmission.

28. A user equipment (UE) comprising:
one or more processors; and
one or more non-transitory computer-readable media (NTCRM) having instructions, stored thereon, that when executed by the one or more processors configure the UE to:
determine that a number of listen-before-talk (LBT) failures on a sidelink channel over a time period exceed a threshold; and
send a report to indicate a consistent LBT failure based on the determination.

29. The UE of claim 28, wherein the UE is in a sidelink mode 1.

30. The UE of claim 28, wherein the UE is in a sidelink mode 2.

31. The UE of claim 28, wherein the report is sent to a gNB.

32. The UE of claim 28, wherein the determination is associated with an attempted transmission of a physical sidelink feedback channel (PSFCH) by the UE.

33. One or more non-transitory computer-readable media (NTCRM) having instructions, stored thereon, that when executed by one or more processors of a user equipment (UE) configure the UE to:
perform a sidelink sensing and resource selection procedure to select sidelink resources for a sidelink transmission;
perform a listen-before-talk (LBT) procedure on the selected sidelink resources; and
if the LBT procedure is successful, perform the sidelink transmission in the selected sidelink resources.

34. The one or more NTCRM of claim 33, wherein the sidelink sensing and resource selection procedure is performed based on an energy detection threshold of the LBT procedure.

35. The one or more NTCRM of claim 33, wherein the sidelink sensing and resource selection procedure includes to sense for activity on resources of a channel and exclude one or more of the resources from a set of candidate resources based on the sensed activity, wherein the sidelink resources for the sidelink transmission are selected from the set of candidate resources.

36. The one or more NTCRM of claim 33, wherein the LBT procedure is performed within a cyclic prefix extension prior to the selected sidelink resources.

37. The one or more NTCRM of claim 33, wherein the selected sidelink resources include contiguous slots.

38. The one or more NTCRM of claim 37, wherein the instructions, when executed, further configure the UE to determine that selection of the contiguous slots is supported based on one or more conditions.

39. The one or more NTCRM of claim 38, wherein the one or more conditions include one or more of:
a packet delay budget of less than a first predetermined value;
a remaining packet delay budget of less than a second predetermined value;
a channel busy ratio (CBR) of less than a third predetermined value; or
a condition based on a priority or channel access priority condition (CAPC) of the sidelink transmission.

40. The one or more NTCRM of claim 33, wherein the sidelink sensing and resource selection procedure is to prioritize resources that are earliest in time.
